(19) United States
(12) Patent Application Publication
(10) Pub. No.: US 2024/0097259 A1
(43) Pub. Date: Mar. 21, 2024

(54) Lithium-Ion Battery System for Forklifts

(71) Applicant: EControls, LLC, San Antonio, TX (US)

(72) Inventors: Kennon Guglielmo, San Antonio, TX (US); Adam Schumann, San Antonio, TX (US); Brent Ludwig, San Antonio, TX (US); Matthew Martin, San Antonio, TX (US); Justin Sanders, San Antonio, TX (US)

(73) Assignee: EControls, LLC, San Antonio, TX (US)

(21) Appl. No.: 18/030,599

(22) PCT Filed: Oct. 8, 2021
(86) PCT No.: PCT/US21/54185

§ 371 Date: Apr. 6, 2023

Related U.S. Application Data
(60) Provisional application No. 63/089,100, filed on Oct. 8, 2020.
(60) Provisional application No. 63/113,292, filed on Nov. 13, 2020.
(60) Provisional application No. 63/132,985, filed on Dec. 31, 2020.

(51) Int. Cl. H01M 50/249; H01M 10/0525; H01M 10/42; H01M 10/48; H01M 10/613; H01M 10/615; H01M 10/625; H01M 10/633; H01M 10/655

(52) U.S. Cl. CPC H01M 50/249; H01M 10/0525; H01M 10/4257; H01M 10/482; H01M 10/486; H01M 10/613; H01M 10/615; H01M 10/625; H01M 10/633; H01M 10/655; B60L 53/80

(57) ABSTRACT

A rechargeable lithium-ion battery assembly configured to provide power to a forklift vehicle, the battery assembly including a plurality of battery modules integrated into the assembly, where each integrated battery module includes a plurality of battery cells within a module casing, with the cells being grouped and interconnected in both series and parallel to provide in combination an overall predetermined electrical potential between a positive terminal and a negative terminal for each module, and where each module uses two conductors within a printed circuit board assembly (PCBA) as busbars, with the PCBA being disposed adjacent to a first end of each battery cell in the module and being electrically coupled by wire bonds with each battery cell, and the PCBA also having a processor (a battery management system, or BMS) for management control of the integrated module. For each battery cell, a first thermally conductive gap filler is disposed to contact the first end of the battery cell and to contact the collector plate, and a second thermally conductive gap filler is disposed to contact a second end of the battery cell as well as the module casing, while heaters and heat dissipating fans are controlled to keep the temperature of the cells in predesigned ranges for charge and discharge according to particular control strategies.

### CLAIM OF PRIORITY TO PRIOR APPLICATIONS

The present application claims the benefit of the filing dates of U.S. Provisional application, Ser. No. 63/089,100, filed on Oct. 8, 2020, and U.S. Provisional application, Ser. No. 63/113,292, filed on Nov. 13, 2020. By this reference, the full disclosures, including claims and drawings, of U.S. Provisional applications, Ser. Nos. 63/089,100 and 63/113,292 are incorporated into the present disclosure as though now set forth in their entirety.

### BACKGROUND

### 1. Field

The present disclosure relates to battery-powered industrial trucks and their rechargeable electric batteries, as well as to related control systems and aspects of their use. More particularly, the disclosure is most directly related to rechargeable battery systems for use in Class I, II or III forklifts but may also find applicability in relation to other classes of battery-powered industrial trucks.

### 2. Description of Related Art

Before reviewing the particular field of the present disclosure, it may be helpful to consider background information on rechargeable lithium-ion batteries in general. Rechargeable lithium-ion batteries were developed in the 1970's, and many of their benefits and potential industrial uses were well understood even then. Although commercial adoption was initially slow, they became much more widely popular by the 1990's. They are principally characterized by reference to the type of intercalated lithium compound used as the cathodes in their battery cells. Lithium metal oxides have been the most successful, with lithium cobalt oxide (LCO, or LiCoO₂) being most popular for use in industry, although its use has not been without drawbacks, particularly with respect to thermal runaway. Through the course of development, substantial improvements have been realized by doping of lithium cathode formulations with additional metals such as nickel, manganese, and aluminum. Various innovations have also involved core-shell particle cathodes, improved anodes, and the use of solid lithium polymer electrolytes, and still other innovations have led to smaller cathode particle sizes, increased electrode surface areas, and other improvements in overall battery capacity.

Today, the most popular lithium-ion batteries are of the LCO type, with lithium nickel cobalt aluminum oxide (NCA, or LiNiCoAlO₂) and lithium nickel manganese cobalt oxide (NMC, or LiNiMnCoO₂) being particularly popular. Other alternative cathode compositions have included other lithium metal oxides such as lithium manganese oxide (LMO) and lithium manganese nickel oxide (LMNO), and other lithium-ion chemistries can be considered for particular needs. Lithium metal phosphates, are another distinct lithium-ion formulation that has also long been theoretically available for improved cycle counts, shelf life, and safety, although other performance trade-offs have made them less popular than LCO types amongst manufacturers. As one particular type of lithium metal phosphate, lithium iron phosphate (LFP, or LiFePO₄) batteries have long been known as an available type of rechargeable lithium-ion battery, with various pros and cons relative to NCA, NMC and other LCO batteries, that have generally weighed against widespread use of LFP.

As a particular example of successful implementation of lithium-ion batteries in other fields, Tesla, Inc. has popularized the use of NCA batteries for its Model S electric cars. Their NCA batteries work well largely due to their high energy density, although they tend to have relatively low thermal stability, with a thermal runaway temperature of around 150° C. Tesla's battery manufacturing method helps balance the benefits and risks by safely interconnecting hundreds of smaller battery cells in a much larger assembly, in a way that enables the necessary energy density while minimizing the risk of arcing and overheating. Within the larger assembly, the hundreds of smaller battery cells are connected in groups, each group including a parallel arrangement of numerous cells connected by wire bonds to adjacent busbars. The busbars of those groups are then combined in series to produce a much larger assembly that meets the power demands for an electric car. The method permanently connects each terminal of each cell into the overall assembly, although rather than using traditional methods of soldering, resistive spot welding, or laser welding, Tesla uses ultrasonic vibration welding, and the wire bonds are made of low resistance wire that allows for expected currents to pass through. Each wire bond is only about a centimeter in length, with one end bonded to the battery terminal and the other end bonded to an aluminum busbar conductor, which in turn is electrically joined in a circuit with other busbars. In the event of overcurrent such as with a short circuit or the like, each wire bond can serve as a fuse that breaks to prevent excessive overheating.

Although LFP batteries tend to have lower energy densities than NCA and NMC batteries (i.e., LFP batteries have less energy per unit mass), they have also long been known to have greater thermal stability. Thermal runaway for LFP batteries typically does not occur until around 270° C., which improves safety and decreases the likelihood of catastrophic failure. LFP batteries are also more stable under short circuit or overcharge conditions and will not readily decompose at high temperatures. As other arguable advantages, LFP batteries also tend to have greater power density (i.e., they can source higher power levels per unit volume) as well as greatly increased cycle life in comparison to lead-acid batteries. While common lead-acid batteries have an average life of 300 cycles with 20% degradation of stored charge, LFP batteries can last over 2000 cycles with the same 20% degradation of stored charge.

Meanwhile in the field of the present invention, despite long availability of lithium-ion batteries in general, Class I, II and III forklifts are still typically powered by lead-acid batteries. One reason is that many forklifts, especially Class I and II forklifts, require a substantial counterbalance for safe use. While lead-acid forklift batteries commonly weigh more than a thousand pounds, many forklifts have been designed to use the additional weight of lead-acid batteries as a counterbalance to maintain stability while burdened with a load. However, their massive weight of the batteries also presents numerous challenges, particularly in the context of extracting, replacing and otherwise handling them. While personnel cannot safely lift anything near that heavy, special hoists and battery changing equipment are required, which in turn involves more expense and floor space, not to mention the risks of back injury and the like.

Beyond the weight-related risks, because of the corrosive nature of sulfuric acid, lead-acid batteries also present risks of damage to eyes, lungs, skin and clothing of personnel who work with them. Plus, hydrogen gas is commonly released during battery recharge, which can combine explosively with oxygen, as well as cause accelerated corrosion of surrounding components. Consequently, special safety protocols are needed with lead acid batteries, and special attention is needed to ensure adequate ventilation of hydrogen and sulfuric fumes around forklifts and their recharging stations.

Moreover, lead-acid forklift batteries are also expensive in terms of time, space and inventory. A lead-acid forklift battery can generally only be used continuously for around six hours before requiring 8-9 hours to recharge. They can also require extensive hours of maintenance and have a much shorter life cycle when compared to lithium-ion technologies. They also tend to require dedication of large areas in warehouses for charging and maintenance, and each forklift generally requires two spare batteries for a facility conducting 24-hour operations.

As a result of many of the above-mentioned and other reasons, others have long considered use of lithium-ion forklift batteries as an alternative, but any resulting attempts have been weak at best, and many of the challenges of the characteristically massive lead-acid forklift batteries still plague forklift-related industries.

Therefore, despite the well-known characteristics and long availability of rechargeable LFP and other lithium-ion battery technologies, there are still substantial and long-felt unresolved needs for battery technology improvements in the forklift industry.

### SUMMARY OF THE INVENTION

The innovations of the present invention improve safe and reliable operations of conventional electric forklifts in various ways, in part by enabling rechargeable lithium-ion forklift batteries that are interchangeable with lead-acid forklift batteries for which such forklifts are conventionally adapted to be used. Many embodiments of the present invention involve rechargeable battery assemblies that are forklift-battery-sized but that comprise multiple battery modules.

The entire assembly can be removed and recharged in the same manner as conventional lead-acid forklift batteries, or the preferred method of charging the entire assembly while it remains in the forklift. Moreover, due to other innovative aspects of Applicant's approach, the larger assembly can be recharged with lithium-ion chargers but are also readily compatible to be recharged with conventional lead acid battery chargers.

Preferred embodiments of the larger battery assemblies include a housing that is forklift-battery-sized, together with a symmetrical arrangement of modules. Preferably, the housing contains eight battery modules installed vertically within the assembly, with their electrical and data connections occurring within the battery. The assembly requires a minimum number of battery modules for continuous operation based on voltage and current requirements of the application.

Each battery module has an integrated battery management system (BMS). The BMS monitors the health to include cell voltage, current, and temperature. The system monitors the state of charge, compensates for voltage differences, and ensures the battery assembly remains operational if and only if the battery cells are properly balanced and within the operating temperature limits. Additionally, the system can retain and communicate history and information to lift trucks and chargers through a physical CAN bus.

Battery modules of preferred embodiments are connected in a combination of series and parallel connections to achieve higher voltage, higher capacity, and/or higher ampacity. Each battery module is self-sufficient containing its own internal battery management system. However, there will preferably be some redundant monitoring and control conducted by secondary controllers, such as by motor controllers, battery chargers, and supervisory processors, such as by a Battery Operating System Supervisor (BOSS) Module.

Within each module, individual battery cells are connected using an approach that is comparable to the Tesla method of wire bonded battery manufacture. An important difference from Tesla, however, involves the use of LFP battery technologies rather than NCA or other LCO battery technologies, as previously discussed. An electrically insulative adhesive is used between the top plastic battery tray and the printed circuit board. Additionally, the same adhesive is used between the battery cells and the top and bottom plastic battery trays. A thermal gap filler is applied between the bottom of the battery cells and the module enclosure for the purpose of thermal management.

Disclosed is an electrically-powered forklift truck configured to be powered by a battery power source. The forklift truck has a battery assembly compartment and a battery assembly configured to provide electrical power to the forklift and disposed within the battery assembly compartment. The battery assembly has an assembly housing sized to operatively fit within the battery assembly compartment and a plurality of battery modules disposed in an interior of the assembly housing, such that each module is integrated into the larger battery assembly. Each of the plurality of integrated battery modules has a module casing, a positive terminal and a negative terminal disposed to be accessible from an outside of the module casing, a plurality battery cells disposed within the module casing and interconnected with the positive and negative terminals to provide a combined electrical potential between the positive and negative terminals, and a printed circuit board assembly (PCBA, which may be more than one board) disposed within the module casing adjacent to a first end of each of the plurality of battery cells. The PCBA is formed with an integral collector plate electrically coupled with each of the plurality of battery cells. The PCBA of each integrated module also includes a processor for controlling aspects of the module's operation, which is preferably embodied as a battery management system (BMS) configured to obtain real-time operational information of the plurality of battery cells.

For each of the plurality of battery cells a first thermally conductive gap filler is disposed to contact the first end of the battery cell and to contact the collector plate, the first thermally conductive gap filler configured to transfer heat between the collector plate and the battery cell, and a second thermally conductive gap filler is disposed to contact a second end of the battery cell and to contact the module casing, the second thermally conductive gap filler configured to transfer heat between the battery cell and the module casing.

According to preferred embodiments of the disclosure, for each of the plurality of battery modules, the corresponding PCBA has a plurality of thermistors disposed on the collector plate, with those thermistors being electrically connected with the BMS (or alternative processor) while the BMS is adapted to determine the approximate temperature within an individual battery cell (or, in alternative embodiments, a plurality of cells) that is in close proximity to the thermistor. For each of the plurality of battery modules, each of the plurality of thermistors is disposed on the collector plate to contact one of the first thermally conductive gap fillers, and each thermistor is configured to measure a temperature of the first thermally conductive gap filler, which is in contact with one of the plurality of battery cells. Each BMS is preferably programmed to use the signal from each individual thermistor to determine an approximate or estimated internal battery temperature for the battery cell(s) in close proximity to the thermistor. More particularly, that approximate or estimated temperature is determined based on the thermistor signal using algorithms that model the thermal characteristics of the battery cell, its casing, and the thermally conductive filler material.

The rechargeable battery assembly also has a plurality of cooling fans configured to cool the plurality of battery modules by moving air past the battery modules and the surrounding structures to which heat is conducted from the cells. In addition, the BMS processor or another processor, such as a Battery Operating System Supervisor (BOSS) module, is adapted to use the temperature approximations to monitor estimated battery temperatures corresponding to each battery module, and that processor is programmed to activate the cooling fans in response to determining that one of the estimated battery temperatures for a battery module is above a threshold temperature. In some embodiments the threshold temperature is a predetermined threshold temperature programmed to the BOSS module. In some embodiments, the threshold temperature is determined by the BOSS module relative to an ambient temperature.

According to some preferred embodiments of the disclosure, the module casing includes a base and a cover, where the base is disposed to be in contact with the second thermally conductive gap fillers, and the base is comprised of aluminum. According to some embodiments, the vehicle is a forklift truck. For each of the plurality of battery modules, each of the plurality of battery cells is a lithium-ion battery cell. Each of the first and the second thermally conductive gap fillers preferably comprises a silicone-based thermally conductive material, although those of skill in the art will be able to determine other types of thermally conductive materials as well.

Many other substitutes, modifications and alternative embodiments will be understood to those of skill in the art, well beyond the embodiments that are described herein, and the reader should understand that the present invention encompasses not only the disclosed embodiments but also those many other substitutes, modifications and alternative embodiments.

### BRIEF DESCRIPTIONS OF THE DRAWINGS

FIG. 1 illustrates a perspective view of a preferred embodiment of the disclosed battery assembly. Height H, Width W, and Depth D of the embodiment are shown for illustrative purposes.

FIG. 2 illustrates a side view of a Class II forklift in a configuration representative of the prior art, showing its inclusion of a conventional lead-acid forklift battery in an openable battery compartment with arrows conceptually illustrating the relationship between its counterweight, the weight of its load, and the resulting center of mass in comparison to the force of the opposing fulcrum created at the front wheels of the forklift.

FIG. 3 illustrates a side view of a Class II Standing forklift without the conventional lead acid forklift battery of FIG. 2, instead incorporating a rechargeable battery assembly according to this disclosure.

FIG. 4A illustrates an exploded view of a main enclosure inner and outer subassemblies of the battery assembly of FIG. 1.

FIG. 4B illustrates an assembled perspective view of the main inner and outer subassemblies of FIG. 4A.

FIG. 5 illustrates an exploded view of the battery assembly of FIG. 1.

FIG. 6A illustrates perspective view of a battery module illustrated in FIG. 5.

FIG. 6B illustrates an exploded view of the battery module of FIG. 6A.

FIG. 7A illustrates a perspective view of the battery module of FIG. 6A without its external covers and enclosure.

FIG. 7B illustrates an exploded view of the battery module illustrated in FIG. 7A.

FIG. 8A illustrates a top plan view of a printed circuit board assembly of the battery module illustrated in FIG. 7B.

FIG. 8B illustrates a bottom plan view of the printed circuit board assembly of FIG. 8A.

FIG. 8C illustrates a top plan view of a printed circuit board assembly, according to an alternative embodiment.

FIG. 8D illustrates a bottom plan view of the printed circuit board assembly of FIG. 8C.

FIG. 9 illustrates a cutaway view of an individual battery cell within a battery module.

FIG. 10A illustrates a schematic diagram where eight battery modules are connected in parallel.

FIG. 10B illustrates a schematic diagram example of an alternative embodiment with the battery modules connected in a series-parallel arrangement.

FIG. 11 illustrates a flowchart of a method of electrically connecting and disconnecting a battery module from an assembly busbar, according to an embodiment of this disclosure.

FIG. 12A illustrates a flowchart of a method of heating battery cells prior to charging battery cells, according to an embodiment of this disclosure.

FIG. 12B illustrates a flowchart of a method of cooling battery cells, according to an embodiment of this disclosure.

FIG. 13 illustrates a graphical representation of a charge curve of a NMC battery and a charge curve of a LFP battery cell.

FIG. 14 illustrates an equivalent circuit model used to determine a battery cell's open circuit voltage and dynamic parameter characterization.

FIG. 15 illustrates a graphical representation of an estimated state of charge curve of a battery cells according to an embodiment of this disclosure.

FIG. 16 is a block diagram illustrating active balancing of battery cell banks.

### DETAILED DESCRIPTIONS OF PREFERRED EMBODIMENTS

The following descriptions relate to presently preferred embodiments and are not to be construed as describing limits to the invention, whereas the broader scope of the invention should instead be considered with reference to the claims, which may be now appended or may later be added or amended in this or related applications. Unless indicated otherwise, it is to be understood that terms used in these descriptions generally have the same meanings as those that would be understood by persons of ordinary skill in the art. It should also be understood that terms used are generally intended to have the ordinary meanings that would be understood within the context of the related art, and they generally should not be restricted to formal or ideal definitions, conceptually encompassing equivalents, unless and only to the extent that a particular context clearly requires otherwise.

For purposes of these descriptions, a few wording simplifications should also be understood as universal, except to the extent otherwise clarified in a particular context either in the specification or in particular claims. The use of the term “or” should be understood as referring to alternatives, although it is generally used to mean “and/or” unless explicitly indicated to refer to alternatives only, or unless the alternatives are inherently mutually exclusive. When referencing values, the term “about” may be used to indicate an approximate value, generally one that could be read as being that value plus or minus half of the value. “A” or “an” and the like may mean one or more, unless clearly indicated otherwise. Such “one or more” meanings are most especially intended when references are made in conjunction with open-ended words such as “having,” “comprising” or “including.” Likewise, “another” object may mean at least a second object or more.

### PREFERRED EMBODIMENTS

The following descriptions relate principally to preferred embodiments while a few alternative embodiments may also be referenced on occasion, although it should be understood that many other alternative embodiments would also fall within the scope of the invention. It should be appreciated by those of ordinary skill in the art that the techniques disclosed in these examples are thought to represent techniques that function well in the practice of various embodiments, and thus can be considered to constitute preferred modes for their practice. However, in light of the present disclosure, those of ordinary skill in the art should also appreciate that many changes can be made relative to the disclosed embodiments while still obtaining a comparable function or result without departing from the spirit and scope of the invention.

### Main Housing and Battery Module Interface Design

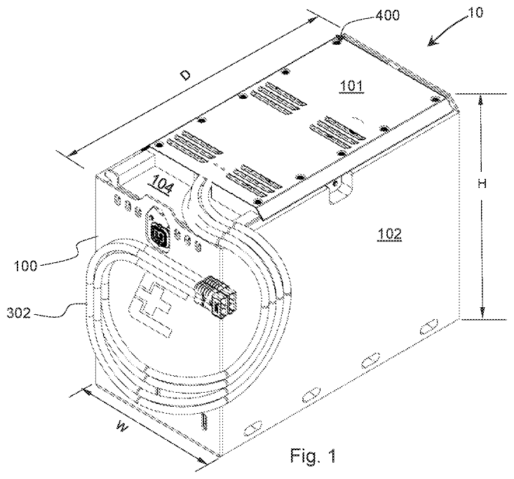

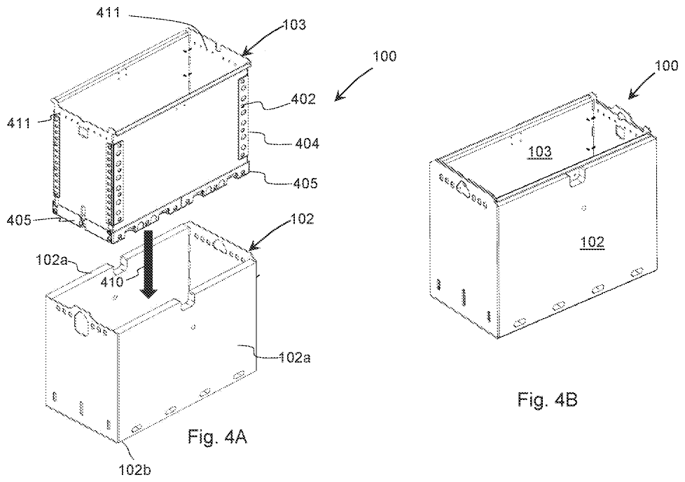

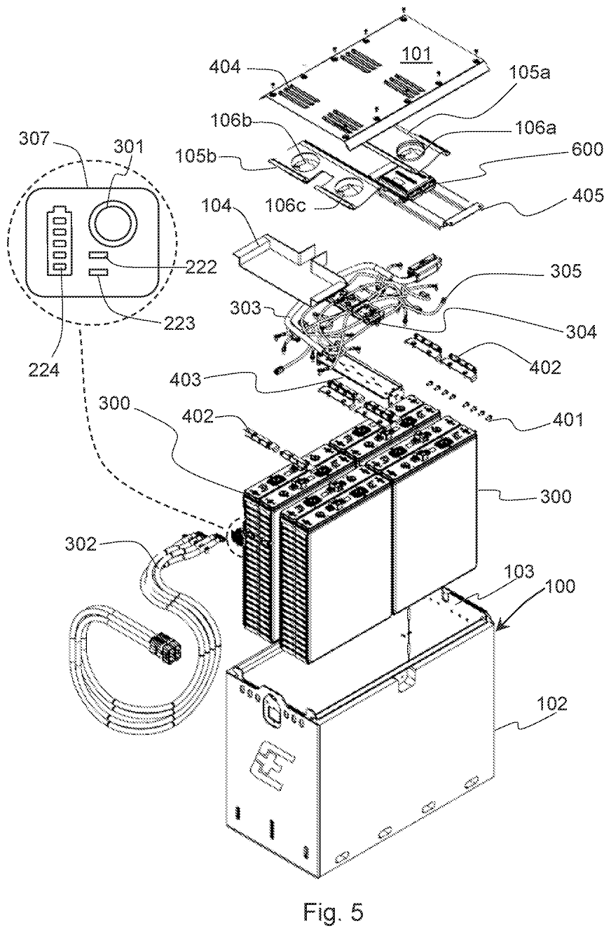

In FIG. 1, there is shown a perspective view of a battery module assembly 10, showing the main enclosure (“housing”) 100 that includes a main cover 101 and an outer frame 102. Housing 100 is preferably constructed of steel or another material suitable for providing strength, stability, and also allowing for sufficient counterweight properties for forklift operations. Battery assembly 10 has eight battery modules (“modules”) 300 arranged vertically, as shown in FIG. 5. When installed in housing 100, each module 300 is enclosed by the main cover 101. A cable tray 104 is interposed between main cover 101 and inner frame 103 (shown in FIG. 4A), which allows cable tray 104 to provide a strain-relieved path for the main power cable under the main cover 101. The main cover 101 is fastened to housing 100 with screws 400. Power from modules 300 are transmitted by the main power cable assembly 302.

### Representative Lift Truck

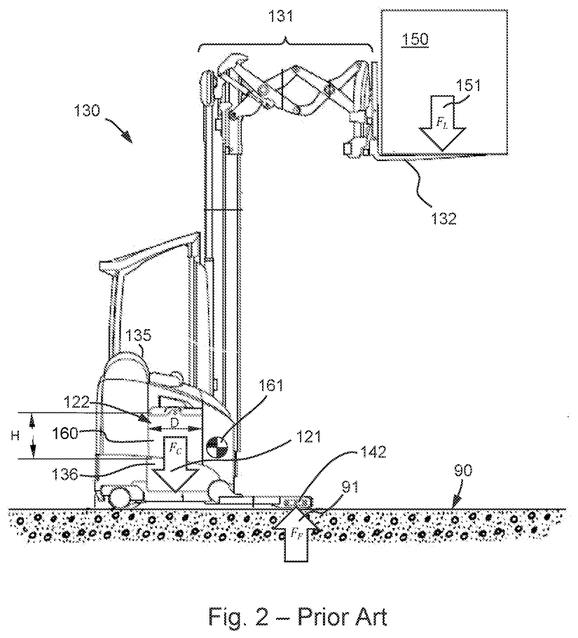

FIG. 2 shows a side view of a conventional Class II electric forklift 130, which is representative of a prior art lift truck design with which and in which the disclosed rechargeable battery assembly 10 may be incorporated, embodied or used. It should be understood that the disclosed rechargeable battery assembly 10 may also be incorporated into other classes of lift trucks, including Class I and Class Ill. The particular model of forklift 130 illustrated is most like a Crown RM6000 series forklift, which specifies a battery that is 38.38 inches long (i.e., the lateral dimension when installed on the forklift)×20.75 inches wide (i.e., depth from front to rear)×31 inches in height and that meets minimum weight requirements. As a Class II forklift, forklift 130 is a mobile truck with a lifting assembly 131 for raising and lowering forks or other load supporting members 132 that are adapted to support a load 150 thereon, for the purpose of lifting, carrying or moving that load 150.

While load supporting members 132 are conventionally designed to support load 150 in a cantilevered fashion, extending forward of a fulcrum generally created by the front wheels 142 of forklift 130, heavier loads present risks of tipping over forklift 130. Hence, minimizing that risk of tipping under load is basic to safe operation of such forklift 130 and, in line with its classification as a Class II lift truck, the full range of weight (F_{L}, illustrated by arrow 151) of loads 150 to be carried by forklift 130 must be properly counterbalanced by a counterweight force (Fc, illustrated by arrow 121). In other words, for safe lifting and maneuvering of load 150 without tipping, the forward-tipping torque created principally by the weight (F_{L}, illustrated by arrow 151) of that load 150 must be exceeded by the opposing torque created principally by the counterweight force 121 (Fc) of forklift 130, particularly for loads at the heavier end of the range of manufacturer specified load capacities for forklift 130.

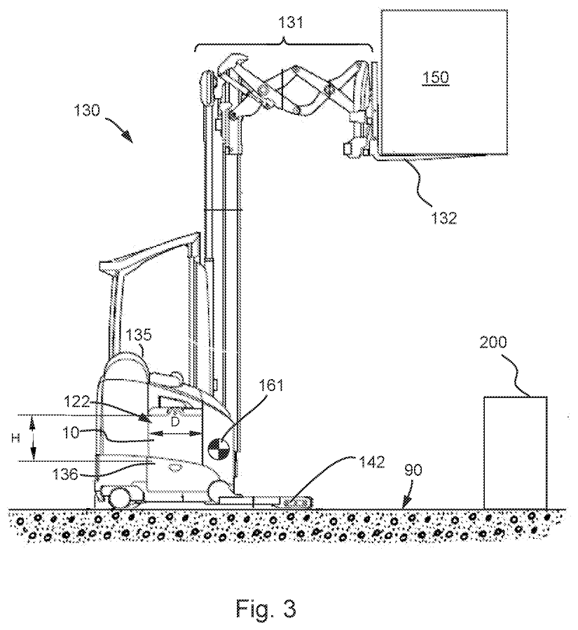

In the prior art, such a forklift 130 generally includes a large lead acid battery 160 as a major part of the counterweight force (Fc), and forklifts are generally designed accordingly. The design of such forklifts generally incorporates structure to safely support the weight of the forklift battery 160 within a battery compartment 122 of a particular length (i.e., depth “D”), height “H”, and width. It should be understood that, with respect to these dimensional characteristics shown in FIGS. 2 and 3, the width dimension is perpendicular to FIGS. 2 and 3.

Battery compartment 122 is generally defined in part by removable or openable panels or the like that partially or completely contain and define the space for lead-acid battery 160 therein. In the case of the illustrated forklift 130, for instance, battery compartment 122 is defined in part by a seat assembly 135 and a partial side panel 136. Seat assembly 135 normally sits over the top of battery 160. Panel 136 or other structures are provided to help enclose and define battery compartment 122, and panel 136 is either removable or openable to enable more complete access to that battery compartment 122, such as for purposes of checking or replacing battery 160 therein. Forklift 130 also has positive and negative electrical conductors for removably connecting the forklift's electrical circuitry to the corresponding terminals of battery 160 through main power cable assembly 302.

Forklift 130 uses a fulcrum (F_{F}, illustrated by arrow 91) which is created between the forklift's front wheels and the underlying floor 90. If the moment created by the load force (F_{L}) of load 150 forward of that fulcrum 91 exceeds the opposite moment of the forklift counterweight (Fc), forklift 130 will tip forward, toward the load 150, resulting in a dangerous situation. The location of the center of gravity 161 depends partly on if the forklift is loaded or unloaded. When the forks 132 are raised while carrying a load 150, the center of gravity 161 naturally shifts toward the front of the forklift and upward.

### Rechargeable Battery Assembly

FIG. 3 shows the same representative Class II electric forklift 130 as illustrated in FIG. 2, but having a preferred rechargeable battery assembly 10 according to the teachings of the present invention operatively installed in the battery compartment 122, in place of the conventional lead acid forklift battery 160 of FIG. 2. In contrast to the conventional lead-acid battery 160, rechargeable battery assembly 10 includes a plurality of separable battery modules 300 (8 in the illustrated embodiment), each of which includes numerous lithium-ion battery cells 710 therein. Most preferably, those numerous battery cells 710 are of lithium iron phosphate (LFP) type battery cells. In some embodiments, battery assembly 10 can hold an operable charge for around ten hours before requiring approximately 60 minutes to recharge, in contrast to the shorter usage durations and much longer charging durations that are characteristic of conventional lead acid battery 160. Also, due to their lithium-ion chemistry, each module 300 can be cycled through about six times as many charging cycles as conventional lead-acid battery 160. Rechargeable battery assembly 10 can be electrically coupled with an external power source 200 to recharge the battery cells 710 of battery assembly 10. In some embodiments, external power source 200 is a charging station for rechargeable battery assembly 10.

For LFP chemistries in particular, charge rates corresponding to one hour or less charge times are often within the recommended operating limits of the cell. The longer run times of rechargeable battery assembly 10 compared to conventional lead-acid batteries 160 also improves workplace efficiency. For lead-acid batteries 160, large areas are allocated for recharging. After an 8-hour work shift ends, lead-acid battery 160 is removed for recharging and another charged lead-acid battery 160 is inserted. Replacing this system with rechargeable battery assembly 10 can save time and valuable space in the work environment.

Another important advantage of rechargeable battery assembly 10 is the lower equivalent series resistance (ESR) in LFP batteries than lead-acid batteries 160. Lead-acid batteries 160 experience decreased performance as a result of having higher ESR. Often as these batteries 160 discharge, a “voltage droop” occurs, causing sluggish operation of the forklift truck under load or acceleration. Most often, this occurs around 6 hours into a shift, requiring an additional recharge per shift, thereby reducing the life of the battery. LFP batteries provide an improvement in sustained performance during shifts while significantly reducing the risk of voltage droop.

Sized, weighted and otherwise adapted to be roughly comparable to the conventional battery 160, the height “H”, depth “D”, and width of battery assembly 10 are substantially the same as those for the conventional forklift battery 160 intended for use with forklift 130. Hence, battery assembly 10 may be described as “forklift-battery-sized”. Due to its forklift-battery-sized characteristic, for forklift 130 as illustrated, battery assembly 10 is able to safely fit in the same battery compartment 122 as conventional battery 160.

Hence, for use on the Class II electric forklift 130 shown in FIG. 3, lithium-ion battery assembly 10 is adapted to fit in a Crown RM6000 forklift battery compartment 122, for use as a replacement of conventional lead-acid battery 160. More specifically, for the RM6000, lithium-ion battery assembly 10 roughly fits the dimensions of 38.38 inches long (i.e., the lateral dimension when installed on the forklift)×20.75 inches wide (i.e., depth from front to rear)×31 inches in height and that meets minimum weight requirements, and battery assembly 10 has a minimum weight of 2600 pounds, preferably with a margin of fifty pounds over the manufacturer's specified minimum battery weight requirement. One with skill in the art will recognize that the concepts disclosed herein can be implemented with a variety of forklifts that vary in size and battery compartment dimensions.

Those of skill in the art will understand that the dimensions, fit, shape and weight for different makes and models of forklifts will dictate a range of dimensions for alternative embodiments that are intended to be used with any particular make and model of forklift. The full range of sizes for Class I-III forklift batteries are intended for alternative embodiments. The range of minimum battery weight requirements for Class I-III electric forklifts are approximately 1,500 to 4,000 lbs., which is also intended for alternative embodiments.

Although many aspects of the present invention can be appreciated with other types of rechargeable battery cells 710, preferred embodiments use battery cells 710 of one of the lithium-ion types. Most preferably, each module 300 of the battery assembly 10 incorporates hundreds of self-contained battery cells 710 of the LFP type. Although all lithium-ion battery types can experience thermal runaway, LFP battery cells of the preferred embodiment have a fairly high thermal runaway temperature, of 270° C., substantially higher than the runaway temperature for NCA or other LCO cells, which are the more conventional of lithium-ion battery cells, which typically have a thermal runaway temperature of around 150° C. Although the preferred embodiment uses LFP batteries, it should be understood that some aspects of the invention can be appreciated through use of other types of rechargeable lithium-ion battery cells. For example, alternative compounds for some aspects of the lithium-ion rechargeable battery assembly 10 are contemplated to include, without limitation, lithium cobalt oxide (LiCoO₂), lithium manganese oxide (LiMn₂O₄, Li₂MnO₃), lithium nickel cobalt aluminum oxide (LiNiCoAlO₂), and lithium nickel manganese cobalt oxide (LiNiMnCoO₂).

Within each of the battery modules 300 of the preferred embodiment, a plurality of self-contained battery cells 710 (in preferred embodiments, there are 372 battery cells 710 per module 300) are connected in a combination of series and parallel using a wire bonding method. The wire bonding method connects battery cells 710 using wire bonds instead of busbars. The wire bonding is achieved through ultrasonic friction welding. By interconnecting battery cells 710 with wire bonding, the wire bonds can prevent short circuits while acting as fuses. The wire bonds are made of Aluminum-Nickel alloy wire that allows for the expected current to pass through without significant overheating and allows the wire bond to break to prevent over-currents of individual cells. Additionally, Field Effect Transistors (“FETs”) or other forms of conventional fuses are placed inside battery modules. If the current carrying capacity is exceeded, the fuse will open and prevent the overcurrent from also fusing the wire bonds. Alternative embodiments of this design may connect battery cells in parallel. Additionally, alternative methods of connecting batteries could include traditional soldering and spot welding.

Referring to FIG. 4A, an exploded view of housing 100 subassembly is shown. Housing 100 subassembly is comprised of an inner frame 103 that is inserted, illustrated by arrow 410, into an outer frame 102. Outer frame 102 comprises two side panels 102a and a bottom panel 102b constructed of heavy gauge steel. Side panels 102a and bottom pane 102b are designed to significantly increase the overall weight of battery assembly 10 so that the battery assembly 10 can act as a counterweight when forklift 130 is burdened by a load. Corner rubber mounts 404 and base rubber mounts 405, attached with the use of push rivets 402, isolate vibration and shock loads between the outer frame 102 and inner frame 103. The assembled housing assembly 100 is shown in FIG. 4B.

Referring to FIG. 5, there is shown an exploded view of battery assembly 10. Preferred embodiments of rechargeable battery assembly 10 have eight battery modules 300 installed in a larger housing 100. Battery assembly 10 preferably contains four sets of two modules 300 arranged two-by-two and vertically oriented within housing 100. Alternative embodiments may have a different location or different quantities of battery modules within the housing 100. Modules 300 can be inserted and removed from the main housing 100. Main cover 101 is coupled to housing 100 to enclose battery assembly 10. As illustrated in FIG. 5, in some embodiments, screws 400 are used to couple main cover 101 to housing 100. However, one with skill in the art will understand that other coupling methods can be used without departing from the scope of the disclosure.

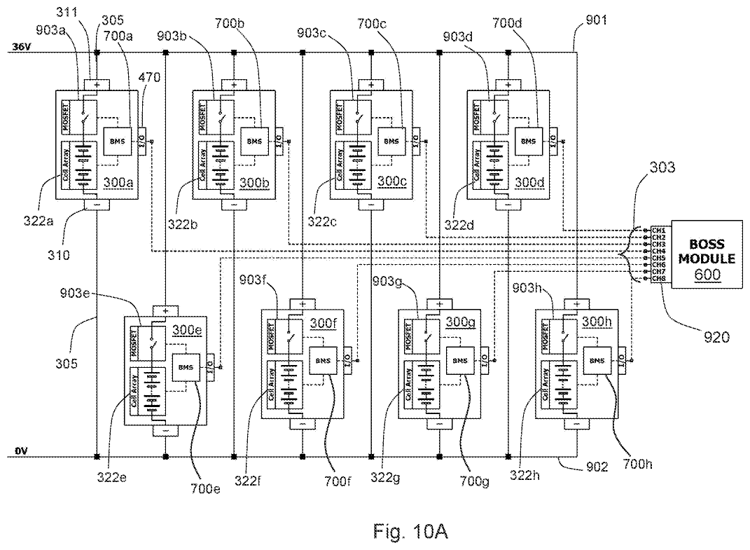

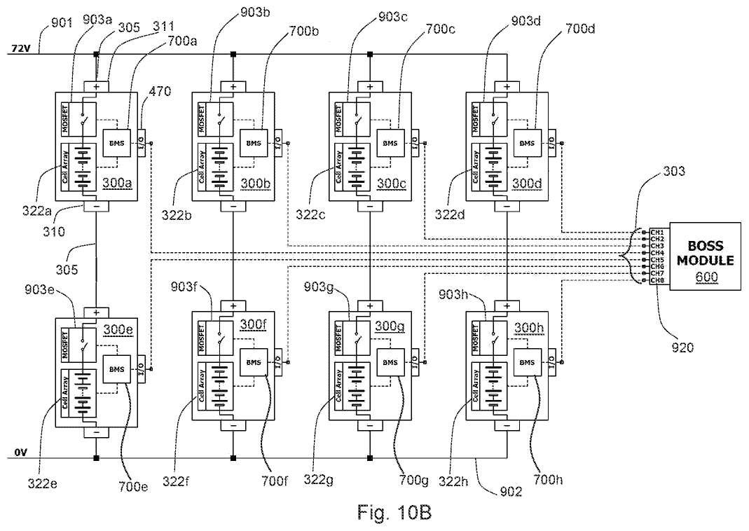

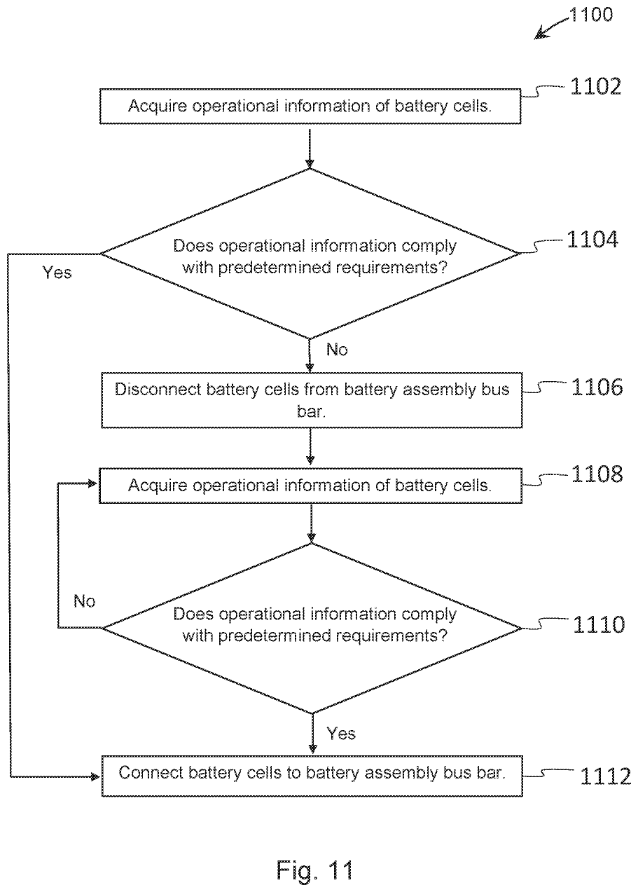

Brackets 402 are located and fastened on the upper corners of each pair of modules 300 and prevent side to side movement of the modules 300 under normal operating conditions. Brackets 402 can be fastened with screws 401 through holes 411 on the front and back surfaces of inner frame 103. A main support bracket 403, which supports a main junction block 304, is attached with four screws on each side of the main inner frame 103. Connected to the main junction block 304 are two battery cables 305 for each module 300 (16 total). Junction block 304 comprises an assembly positive busbar 901 and an assembly ground busbar 902 (as depicted in FIGS. 10 and 11) that electrically connect battery modules 300. Specifically, each battery module comprises a positive bus terminal 311 and a negative bus terminal 310, and battery cables 305 electrically connect the terminals 310, 311 of each module 300 with busbars 901, 902. As discussed in further detail below, in some embodiments, modules 300 are connected in parallel (FIG. 10A) such that each positive bus terminal 311 is connected to positive busbar 901 and each negative terminal 310 is connected to ground busbar 902. In some embodiments, modules 300 are connected in a series-parallel arrangement (FIG. 10B). Main power wire assembly 302 is electrically coupled with modules 300, and is configured to interface with a power input port of forklift 100. Accordingly, main power wire 302 is configured to deliver battery power stored by the modules 300 to the input port of the forklift to power operation of the forklift.

Shown below the main cover 101 of housing 100 are fan assemblies 105a and 105b and a Battery Operating System Supervisor (BOSS) Module 600, which represents a preferred embodiment of a top-level supervisory processor (or, in some embodiments, a group of processors) for controlling the battery assembly 10. In addition to programming for other functions, the BOSS module 600 is preferably programmed and connected to coordinate the various battery cell modules 300 to achieve the desired overall voltage potential between the positive and negative terminals of the larger battery assembly 10, to which the main power cable assembly 302 is operatively connected.

Preferably, direct current (DC) brushless fans 106 are used to cool the modules 300 by moving air past modules 300. A first fan 106a, shown immediately below main cover 101, is located above the first and second modules 300. A second fan, which cannot be seen but is located next to fan 106a on fan mount 105a, is located above the third and fourth modules 300. A third fan 106b is disposed above the fifth and sixth modules 300. A fourth fan 106c is disposed above the seventh and eighth modules 300. Vents 404 on the main cover 101 allow airflow into and out of the interior of the battery module assembly 10. The fan mounts 105a, 105b rest between the main cover 101 and the inner frame 103. Different numbers of fans are also contemplated by the inventor for the purpose of providing module cooling.

BOSS 600 is configured to control fans 106. BOSS 600 is configured to take temperature readings from temperature sensors 812 (discussed in further detail below) of each of the modules 300 and estimate a temperature of battery cells 710 of each module 300. In some embodiments, temperature sensors 812 are thermistors. BOSS 600 is configured to activate fans 106 to cool modules 300 in response to determining that the estimated battery temperature has surpassed a threshold temperature.

A button pad 301 is configured and adapted to display diagnostics for the battery module assembly 10. A user can press button pad 301 to “wake” a display 307 from sleep mode. A coded push can be used for diagnostics. There is a status bar 222 that indicates the present status of the battery assembly 10. If a fault bar 223 lights up red, this indicates that there is a fault with at least one module 300. There are five bars 224 that light up green, using light emitting diodes (LEDs) and indicate the battery charge level of modules 300. The five bars 224 show charge status in increments of approximately 20% of charge ranging from 0% to 100% based on the number of LEDs illuminated. For example, one bar indicates that the charge of modules 300 is very low (around 20%) and five bars indicates that modules 300 of battery assembly 10 are fully charged (100%). State of charge is determined, at least in part, on measuring the current output of each operating battery module 300 using a current sensor. The overall state of charge for battery assembly 10 reflects the average current output of all of the presently operating battery modules 300, and is discussed in greater detail below. Display 307 also has a fault indicator which is lit when one or more battery modules 300 experiences a fault condition. One or more battery modules that are in a present fault condition can be shut off such that those one or more battery modules are no longer operating and do not generate power. Any battery module 300 that is not presently operating is not used to determine the overall state of charge for battery assembly 10.

### Preferred Design of Battery Module and Battery Cell Network

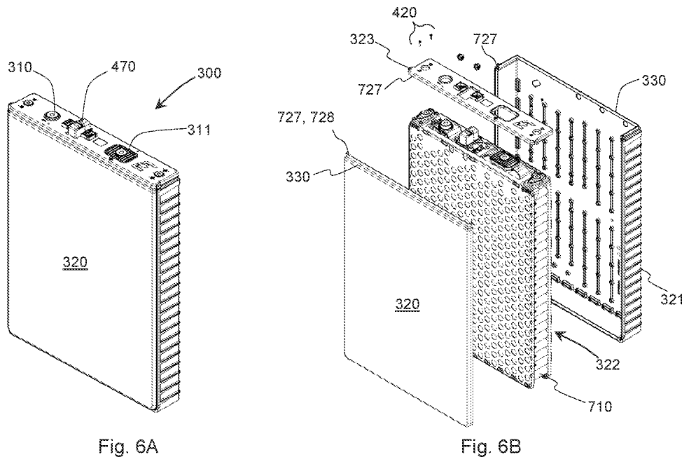

FIG. 6A illustrates an isolated view of module 300. On a top surface of each module 300, a 6-pin signal connector 470, a positive bus terminal 311 and a negative bus terminal 310 are mounted and accessible. A protective enclosure base 320, a cover 321, and an endcap 323 are coupled together to enclose module 300 and seal an interior of module 300 from the outside. Cover 321 is preferably constructed of plastic, although enclosure base 320 is preferably constructed of aluminum (or other thermally conductive material) so that it can serve as a heat sink to help draw heat generated by the battery cells 710 away from those battery cells, while the base 320 has a relatively large surface area that allows the heat absorbed therein to be further exchanged with the atmosphere surrounding the base 320. The heat exchange between the base 320 and the surrounding atmosphere is further enabled by one or more cooling fans 106.

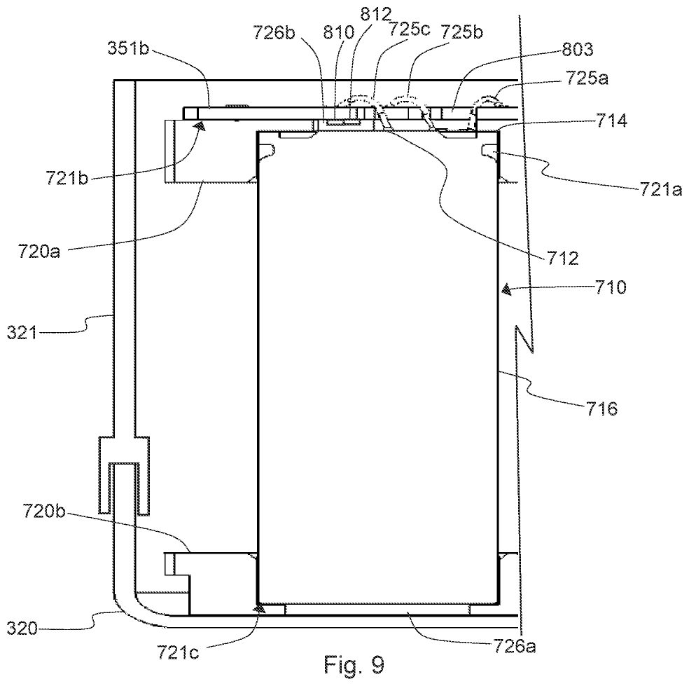

FIG. 6B illustrates an exploded view of the battery module 300 subassembly. Module 300 comprises a cell array 322, which is protected by enclosure base 320 and cover 321. Endcap 323 is fastened to the cell array 322 with four screws 420. Enclosure base 320 and cover 321 are positioned with locater tabs 330 along the top edges to fit inside the endcap 323. An adhesive 728 is applied as required to inner edges of the enclosure base 320. In preferred embodiments, the adhesive is an acrylic adhesive, but the use of other types of adhesives or sealants is contemplated. A sealant 727 is applied as required to enclosure base 320, cover 321 and the endcap 323 for the purpose of sealing the interface between cover 321, endcap 323, and enclosure base 320. In preferred embodiments, the sealant may be a silicone-based sealant, but use of other sealants with similar properties is contemplated. As illustrated in FIG. 9, a thermally conductive gap filler 726a is applied as required between the cell array 322 and the enclosure base 320. As discussed in greater detail below, the gap filling material 726a allows heat to be transferred from the battery cells to the enclosure 320 so it can dissipate from the module 300. Each of these compounds is preferably electrically insulative.

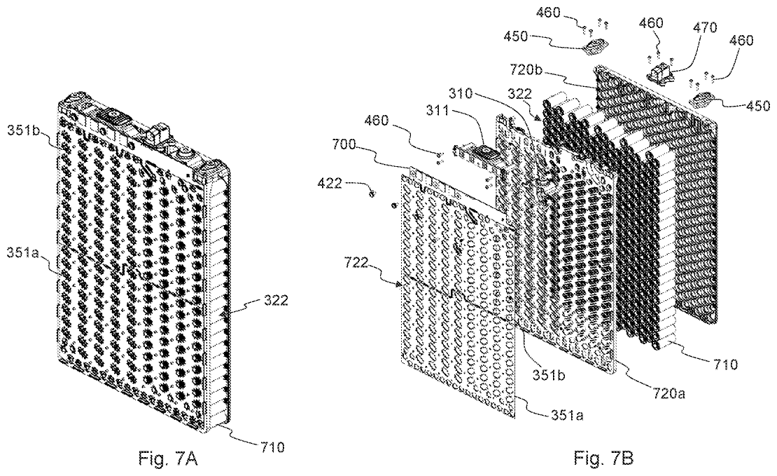

FIG. 7A illustrates a perspective view of the battery module 300 without the cover 321, enclosure base 320, or endcap 323. As illustrated, each battery module 300 includes a printed circuit board assembly (PCBA) 722, which includes two printed circuit board (PCB) collector plates 351a, 351b, and a battery management system (BMS) 700. The two collector plates 351a and 351b are designated as “collector” plates because they contain multiple copper layers that serve as busbars that are integral with the PCBA 722. As will be understandable to those familiar with PCB construction, while the PCBA 722 may contain ten copper layers, a number of those layers (for example, six layers in one preferred embodiment) are dedicated to serving as busbars, while other layers are dedicated to signaling and the like. It should be recognized, however, that a single layer of the collector plate will include multiple busbars at different voltages, depending on the layout of choice for achieving the desired voltage. For instance, while each cell has a voltage of approximately 3.2 volts, the circuitry preferably combines 12 banks of cells in series in order to deliver a total voltage of 36 volts for single module, and the circuitry preferably combines 16 banks of cells in series in order to deliver a total voltage of 48 volts for a single module. Moreover, for each of the voltage levels, a portion of one of the copper layers is laid out to serve a busbar at that voltage. Hence, within a single module or battery cell subassembly, there would ordinarily be one bank of a number of lithium ion battery cells that are wire bonded between portions of the copper layers that are serving as a busbar of zero volts (or grounded) and 3.2 volts, there would be another bank of an equal number of cells that are wire bonded between portions of the copper layers that are configured and connected to serve as busbars of 3.2 and 6.4 volts, and so on, to achieve the total desired voltage.

Although the illustrated PCBA 722 includes three separate pieces, one with skill in the art will understand that, in some embodiments, PCBA 722 is a single piece that includes a large collector plate and a BMS.

FIG. 7B illustrates an exploded view of the battery module 300 shown in FIG. 7A. Each battery cell 710 is wire bonded to PCBA 722. Located between battery cells 710 and PCBA 722 is a top plastic battery tray 720a and an adhesive 721. Positioned below the battery cell array 322 is a bottom plastic battery tray 720b. Plastic battery trays 720a, 720b are placed directly on top of and below the battery cells 710. The glue 721 is used between battery trays 720a, 720b and PCBA 722, as illustrated in FIG. 9. The glue 721 is also an electrical insulator. It should be understood to those skilled in the art that application of the glue 721 is “as required”. Module 300 mounting pieces 450 are secured to a top end of cell array 322 by screws 460.

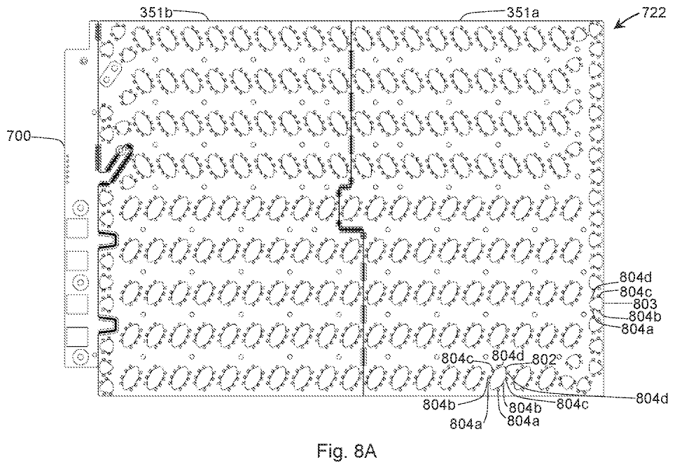

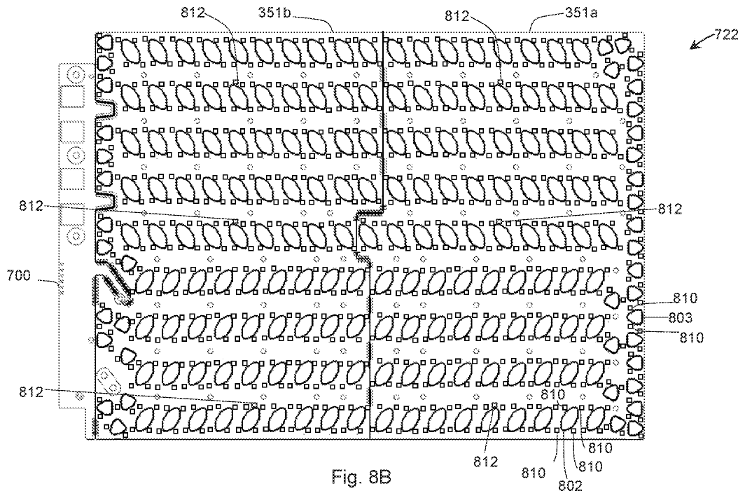

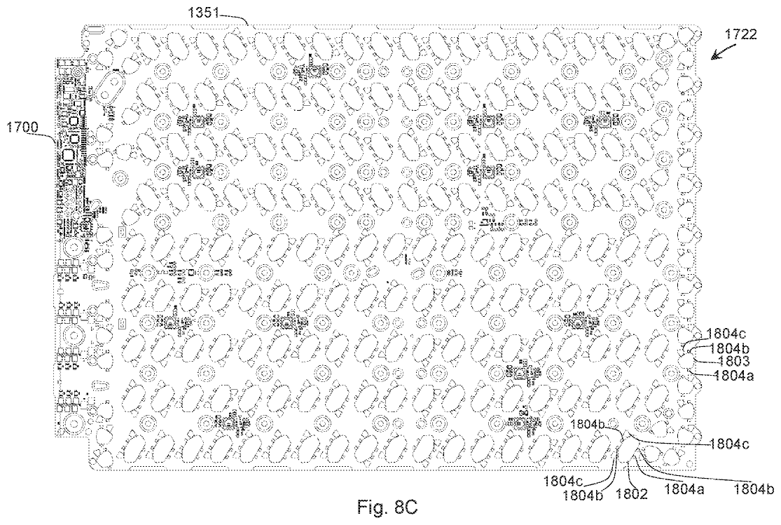

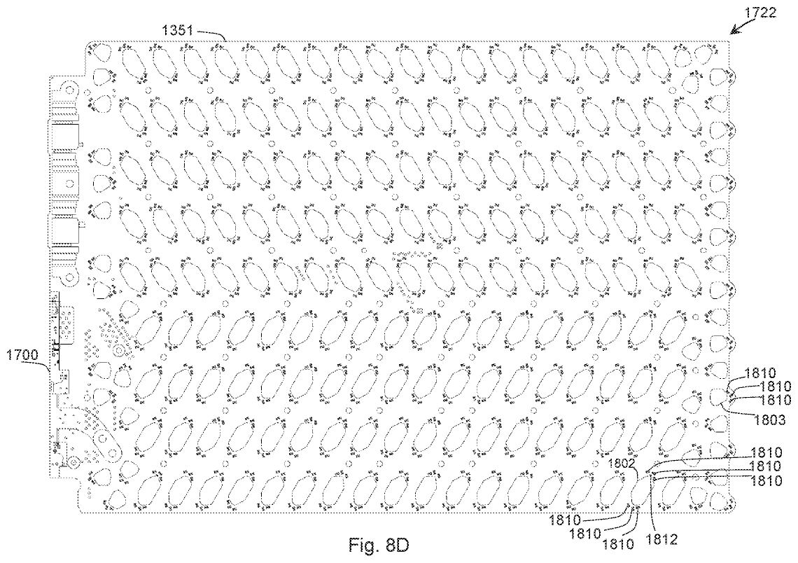

FIG. 8A illustrates a top plan view of PCBA 722. As previously mentioned, PCBA 722 comprises two PCB collector plates 351a and 351b and a BMS 700. Each battery cell 710 is wire bonded to the PCB 722. There are three wires 725a, 725b, 725c (shown in FIG. 9) bonded to pads 804a, 804b, and 804c, on the PCB collector plate 351a, 351b for each battery cell 710. Two of the wires 725a, 725b are for the negative terminal of the individual cell and are bonded to negative pads 804a, 804b, and one of the wires 725c is positive for the individual cell and is bonded to positive pad 804c. The purpose of two negative wires is for redundancy. An additional positive pad 804d is provided for embodiments in which a redundant positive wire is incorporated. One with skill in the art will recognize that, in some embodiments, the PCB collector plates 351a, 351b do not incorporate positive pads 804d.

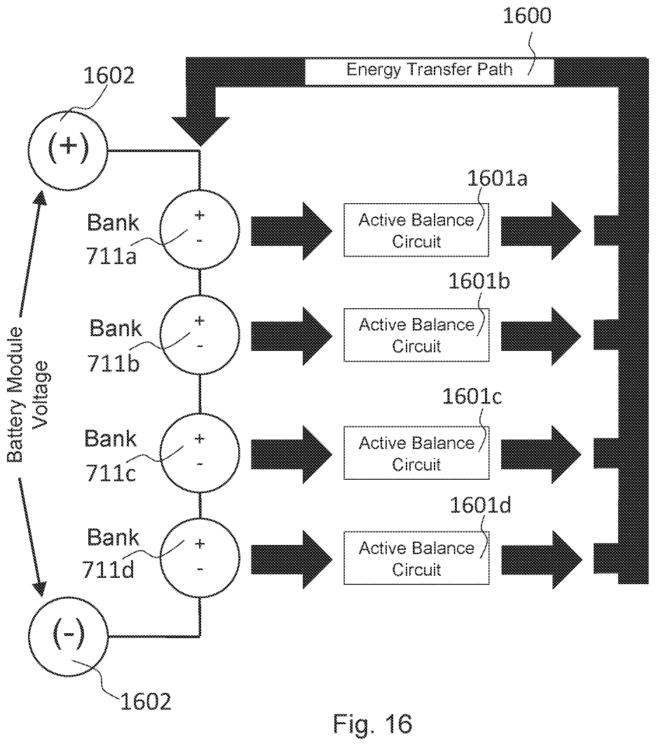

As discussed in further detail in FIG. 16, the battery cells 710 can be divided into groups of battery cells called battery banks 711. BMS 700 can monitor voltage, temperature, and state of charge for battery banks 711. Alternate embodiments may contain variations of the arrangement or numbers of battery cells 710.

Each collector plate 351a, 351b has a plurality of openings 802, 803 through which the battery cells 710, which are adjacent to the bottom side of PCBA 722, can be accessed from the top side of PCBA 722. As illustrated, collector plates 351a, 351b comprise large openings 802 and small opening 803. Each large opening 802 is associated with, and provides access to, two of the battery cells 710, while each small opening 803 is associated with, and provides access to, one battery cell 710. The wires 725a, 725b, 725c associated with each battery cell 710 pass through the cell's 710 associated opening 802, 803 and are bonded to collector plate 351a, 351b at associated bonding pads 804a, 804b, and 804c. Because large openings 802 are each associated with two battery cells 710, there are two sets of bonding pads 804a-804d associated with each large opening 802. Because small openings 803 are each associated with one battery cell 710, there is one set of bonding pads 804a-804d associated with each small opening 803.

In preferred embodiments, bonding pads 804a-804d comprise electroplated gold, and wires 725a, 725b, 725c are bonded to bonding pads 804a-804d with an aluminum-nickel alloy. As previously discussed, enclosure 320, cover 321, and end cap 323 are sealed together when constructed. The sealing of enclosure 320, cover 321, and end cap 323 prevents moisture from entering module 300. Without proper sealing, unwanted moisture can enter module 300 and can cause galvanic corrosion to occur between the electroplated gold pads 804a-804d and aluminum bonded wires 725a, 725b, 725c.

FIG. 8B illustrates a bottom side view of PCBA 722, the opposite side of the view shown in FIG. 8A It has been observed that damage to lithium-ion battery cells 710 may occur when attempting to charge lithium-ion battery cells 710 when the ambient temperature is low, particularly a temperature below 0° C.-5° C. In order to prevent such damage to the lithium-ion battery cells 710 during recharging, particularly when the ambient temperature is low, disclosed embodiments include resistive heating devices 810 mounted on collector plates 351a, 351b in close proximity to each lithium-ion battery cell 710. One example of a resistive heating device that may be incorporated in the disclosed embodiments is a 1206 thick film pick and place surface mount resistor, although other suitable resistors may be used. Each battery cell 710 is associated with at least one associated resistive heating device 810. In some embodiments, such as the embodiment illustrated, there can be two heating devices 810 associated with each battery cell 710. As shown in FIG. 8B, there are four resistive heating devices 810 surface mounted to collector plates 351a, 351b near each large opening 802 and two heating devices 810 surface mounted to collector plates 351a, 351b near each small opening 803. As previously described, each large opening 802 is associated with two battery cells 710, and each small opening 803 is associated one battery cell 710. Accordingly, each battery cell 710 is disposed in proximity of two heating devise 810 of the battery cell's 710 associated opening 802, 803.

Given that the battery module 300 is essentially a closed system, the heat from the resistive heating devices 810 is able to radiate through the battery module system 100 in order to raise the temperature of each lithium-ion battery cell 506 above a set threshold temperature. Preferably, resistive heating devices 810 are positioned close to the rim of each lithium-ion battery cell 710. As discussed in greater detail below, because an outer casing 716 (as illustrated in FIG. 9) for each battery cell 710 is preferably constructed of metal, and more preferably constructed of nickel plated carbon steel, the case of each lithium-ion battery cell 710 is thermally conductive, and preferably an efficient heat conductor to more quickly raise the temperature of each lithium-ion battery cell 710 prior to recharging.

In addition to the resistive heating devices 810, some embodiments may also utilize a thermally conductive material to decrease the time necessary for heating the lithium-ion battery cells 506 to the set threshold temperature. For example, a small amount of the thermally conductive gap filling material 726b (shown in FIG. 9) or a thermal adhesive may be placed on and/or under each of the resistive heating devices 810 to help direct heat from resistive heating devices 810 to the battery cells 710. Placing a small amount of the thermally conductive gap filling material 726b in this way further helps to reduce localized heating effects that could interfere with the accurate measurement of the temperature of lithium-ion battery cells 710 by thermistors 812. Other alternatives for directing heat from the resistive heating devices 810 to the lithium-ion battery cells 506 include a thermal grease or a sheet material that is a cured version of the thermally conductive gap filling material 726b for use as described.

To assist with better circulation of the heat generated by resistive heating devices 810, some embodiments may include one or more fans positioned within the interior of battery module 300. Addition of one or more fans creates convection of the heat generated by resistive heating devices 810 to more quickly raise the temperature of each lithium-ion battery cell 710. Preferably, the one or more fans are mounted in the most effective position to circulate the heated air. Each fan is preferably about 40 millimeters (mm) in diameter. However, other size fans are contemplated, including fans that are smaller than 40 mm, as well as larger fans such as those fans that are 60 mm, 80 mm, 120 mm, or even 140 mm in diameter. Use of one or more fans may optimize the air, and thus heat, circulation within the interior of battery module 300 such that fewer resistive heating devices 810 may be required and/or smaller resistive heating devices 810 may be used.

For measuring temperatures near battery cells 710, a plurality of temperature sensors 812 are mounted on collector plates 351a, 351b. Although temperatures sensor 812 are referred to as thermistors throughout this specification, one with skill in the art will recognize that other types of temperature sensor can be used other than thermistors. Thermistors 812 are electrically connected with BMS 700 such that BMS 700 and thermistors 812 are together configured to take temperature measurements. Thermistors 812, with BMS 700, take temperature readings inside the battery module 300, such that sensed temperature readings from thermistors 812 are communicated to BMS 700. Thermistors 812 are positioned in proximity to the lithium-ion battery cells 710.

FIGS. 8C and 8D illustrate top and bottom views, respectively, of PCBA 1722, which is an alternative embodiment of PCBA 722. One with skill in the art will understand that module 300 can incorporate either of PCBA 722 or PCBA 1722.

Referring to FIG. 8C, a top view of PCBA 1722 is illustrated. PCBA 1722 comprises a collector plate 1351 which is substantially the same as collector plates 351a, 351b, and BMS 1700 which is substantially the same as BMS 700. Unlike PCBA 722, in which BMS 700 and collector plates 351a, 351b are three separate pieces, BMS 1700 and collector plate 351 are integrated as a single piece. Collector plate 1351 comprises large openings 1802 which are substantially the same as large opening 802, and small openings 1803 which are substantially the same 803. Similar to openings 802, 803, large opening 1802 is associated with and provides access two battery cells 710 and small opening 1803 is associated with and provides access to one battery cell 710. Collector plate 1351 comprises wire bonding pads 1804a-1804c, which are substantially the same as bonding pads 804a-804c. Negative boding pads 1804a, 1804b are configured to be boned with a cell's 710 associated negative wires 725a, 725b, and positive bonding pad 1804c is configured to be boned with the cell's 710 positive wire 725c. Unlike collector plates 351a, 351a, which comprise four bonding locations 804a-804d for each battery cell 710, collector plate 1351 comprises three bonding locations 180a-1804c for each battery cell 710.

FIG. 8D illustrates a bottom view PCBA 1722. PCBA 1722 comprises a plurality of resistive heaters 1810, substantially the same as heaters 810. Six heaters 1810 are in proximity of each large opening 1802, and three heaters 180 are in proximity to each small opening 1803. Accordingly, in this embodiment, one with skill in the art will understand that each battery cell 710 is in proximity to three heaters 1810. Additionally, collector plate 1351 includes a plurality of thermistors 1812, which are substantially the same as thermistors 812. Each thermistor is in close proximity to a battery cell 710.

Although the drawings illustrate that each battery cell 710 is associated with two or three heaters 810, 1810, one with skill in the art will recognize that each battery cell 710 can be associated with more or less that two or three heaters 810, 1810, according to other embodiments of this disclosure.

FIG. 9 illustrates a cutaway view of a single battery cell 710 in place within module 300. As previously mentioned, battery cells 710 and other components are surrounded by a protective enclosure 320 and cover 321. Above battery cell 710, there is a plastic battery tray 720a. Adhesive 721a is used between the top of battery cell 710 and top battery tray 720a. Similarly, an adhesive 721b is applied between the top battery tray 720a and collector plate 351b. Preferably, each of these adhesives 721a, 721b are structural adhesives. Furthermore, in preferred embodiments, adhesives 721a, 721b are not electrically conductive. Each adhesive 721a, 721b may be a urethane-based adhesive, an acrylic adhesive, or another type of adhesive that provides similar functionality. Adhesive 721c is applied between the bottom of battery cell 710 and bottom battery tray 720b. Furthermore, a thermally conductive gap filling material 726a is used between the bottom of battery cell 710 and enclosure 320. The gap filling material 726a allows heat to be transferred from the battery cells to the enclosure 320 so the heat can be transferred and dissipated from each battery cell 710. As previously mentioned, in preferred embodiments, enclosure 320 is made of aluminum, which thermally conductive material is effective in dissipating heating from battery cells 710 to outside of module 300. In preferred embodiments, gap filling material 726a, 726b is a silicone-based material. Specifically, in preferred embodiments, gap filler material 726a, 726b is CoolTherm® SC-1600 thermally conductive silicone gap filler, which is a two-component thermally conductive silicone system comprising a resin and a hardener, and has a thermal conductivity of value of 3.7 Watts per meter Kelvin. Gap filler material 726a, 726b, and specifically CoolTherm® SC-1600, can be applied to the ends of battery cell 710, as shown in FIG. 9, using an applicator gun or an XY robotic dispenser table and can be cured for 24 hours at room temperature or for 30 minutes and 100° C.

As previously described, each battery cell 710 is wire bonded to PCB collector plate 351b. FIG. 9 illustrates that positive wire 725c and two negative wires 725a, 725b pass through opening 803 and are wire bonded to the top of PCB collector plate 351b. Positive wire 725c is connected to a positive terminal 712 of battery cell 710. Positive terminal 712 is located at a center portion of the top end of battery cell 710. Negative wires 725a, 725b are connected to a negative terminal 714 of battery cell 710. Negative terminal 714 is located along an outer circumferential raised edge of the top end of battery cell 710. Although FIG. 9 depicts a battery cell 710 associated with PCB collector plate 351b and opening 803, one with skill in the art will understand that each battery cell 710 is assembled with the associated PCB collector plate 351a, 351b and opening 802, 803 according to what is disclosed FIG. 9.

In addition to be disposed at the bottom of battery cell 710, and as previously discussed, thermally conductive material 726b is also disposed at a top end of battery cell 710 between battery cell 710 and PCB collector plate 351b. Specifically, conductive material 726b is disposed to contact the top of end of battery cell 710 and heater 810 of PCB collector plate 351b. Accordingly, thermally conductive material 726b is configured to transfer heat between PCB collector plate 351b and battery cell 710. Specifically, thermally conductive material 726b is configured to efficiently transfer heat produced by heater 810 to battery cell 710.

Additionally, as illustrated in FIG. 9, for openings 802, 803, in proximity to thermistors 812, thermally conductive material 726b is disposed between the top of battery cell 710 and thermistor 812. With this arrangement, in addition to its close proximity to battery cell 710, thermistor 812 can obtain a more accurate temperature reading of cell 710 due to its thermal connection with cell 710 via thermally conductive material 726b.

Battery cell 710 has an outer casing 716 comprised of a thermally conductive material. Outer casing 716 is configured to transfer heat between battery cell 710 and gap fillers 726a, 726b. Specifically, outer casing 716 is configured to transfer heat generated by battery cell 710 to the lower gap filler 726a contacting enclosure 320. Accordingly, the thermally conductive properties of casing 716 assist in transferring heat generated by battery cell 710 to an outside of module 300. Further, outer casing 716 is configured to transfer heat generated by heater 810 throughout the battery cell 710. Accordingly, as will be discussed in further detail below, in cold weather situations, the thermally conductive properties of casing 716 assist in the transfer of heat from heater 810 to battery cell 710. Additionally, due to casing's 716 thermally conductive properties, thermistor 312 can gather more accurate temperature readings of battery 710. In preferred embodiments, casing 716 comprises a metallic material, such as, for example, nickel plated carbon steel.

Referring back to FIG. 8A, BMS 700 monitors the health of the module 300 to include cell voltage, current, and temperature. The battery cells 710 of module 300 are connected in series and parallel via wire bonding and ultimately terminate into integrated BMS 700. The wire bonding is completed using a method similar to the Tesla ultrasonic friction welding method. The opening 802, 803 shown are used to wire bond the battery cells 710 to the PCB 722. Passing through each opening 802, 803 in PCBA 722, wires 725a, 725b, 725c are bonded to both the PCB 722 and the battery cell 710. The PCBA 722 is then used to directly transfer the electric current through the interior of the battery module 300. The use of the wire bonds 725a, 725b, and 725c prevent the entire battery module 300 from failing if one battery cell 710 malfunctions because the other cells are still connected to the PCBA 722.

### Charge Management Systems Integration

FIG. 10A is a schematic diagram illustrating a charge management system, where eight battery modules 300a-300h are connected in parallel with each other and BOSS 600. At any particular point in time, each battery module 300a-300h may have a different state of charge, particularly as the module charges are drained through use in powering the forklift. The “state of charge” is defined as the percentage of charge the module 300a-300h currently has. Each module 300a-300h may be at a different initial voltage due to differences in battery capacity or initial charge levels.

It is necessary for BOSS 600 to serve as a battery management system for the modules 300a-300h. But for the control of BOSS 600, in such scenarios where the voltage in one module exceeds the others, the lower voltage battery modules would draw a current flow from the higher voltage modules into the lower voltage modules that would be only limited by resistance of the connectors, cells, busbars, and bond wires. A large difference in voltage would cause high current flow to the battery module with lower voltage. These situations are undesirable because the current flow to the motor is reduced as current flows between battery modules 300, rather than out of the battery assembly 10 to forklift 130. If a high current is maintained for an extended period of time, or the voltage discrepancy is high enough such as to produce a current higher than the handling capability of the bond wires, it can also lead to battery failure by draining the battery rapidly or opening the bond wires.

As previously mentioned, junction block 304 comprises assembly positive busbar 901 and assembly ground busbar 902, to which the modules 300a-300h are connected. As illustrated in FIG. 10A, in some embodiments, modules 300a-300h are connected in parallel, where negative terminals 310 of modules 300a-300h are connected to ground busbar 902 via cables 305, and positive terminals 311 of modules 300a-300h are connected to positive busbar 901 via cable 305. As previously described, BOSS 600 grants permissions to battery modules 300a-300h to determine which are internally electrically connected to the busbars and which modules 300a-300h are disconnected, by sending signals to the modules 300a-300h. Modules 300a-300h then use a multi-gate field-effect transistor (MOSFET) switch 903a-903d to connect and disconnect module 300a-300h from positive busbar 901. One with skill in the art will understand that although MOSFET switches 903a-903d are described for connecting and disconnecting the modules 300a-300h from positive busbar 901, other types of electrical switches can be used instead of a MOSFET type switch in other embodiments of the disclosure.

It should be understood that module 300d is used here in the following description only as an example, and that each module 300a-300h is wired and employed in the same manner. Communication between the BOSS module 600 and the modules 300a-300h is accomplished by wire harness 303. Arms of wire harness 303 (depicted as dashed lines) connects to each of the battery modules 300a-300h via their respective six-pin electrical connectors 470, and connects to BOSS 600 via a vehicle bus 920. Five pins of each six-pin electrical connectors 470 are “isolated,” with one spare pin not currently utilized but may be employed later. The term “pin” is also used here when describing the wires corresponding to their respective pins in wire harnesses 303. The isolated pins are grouped as part of an isolated wire harness 303. It will be understood by those of ordinary skill in the art that “isolated” refers to galvanic isolation. Transformers and digital isolators are used to separate the isolated wire harness 303 from the main power supply. If an electrical short occurs in the isolated wire harness 303, there is no risk of damage to the rest of the circuits in the system. The isolated wire harness 303 is depicted as the upper dashed line connected to module 300d. Isolated wire harness 303 also connects to the vehicle bus 920. When a module 300d is connected the BOSS module 600, a pull-up or pull-down resistor allows the BOSS 600 to detect the module. Once detected, a pulse train of a specific frequency is transmitted from the BOSS 600 to the battery module 300d which defines the CAN address for the module 300d. There are two pins for communication between module 300d and BOSS module 600; particularly, there is a CAN HI pin and a CAN LO pin. Lastly, there is a ground pin on isolated wire harness 303. Once an address and communication are established, the BOSS module 600 can then grant permissions to module 300d to connect to the busbar 901.

An example of the importance of the BOSS module 600 can be understood during continuous operation of a forklift and one module 300d has a fault. While the fault persists, the state of charge of module 300d will not change while the others will. Once the fault clears, module 300d will be ready to engage, but will not do so due to the difference in stage of charge. The BOSS will permit the modules with higher state of charge to engage the bus, and once their stage of charge has realigned with the orphaned module 300d, the orphaned module 300d will be permitted to engage. For example, a forklift carrying a load and driving up a hill would require a lot of current. The BOSS module 600 does not control the disconnection and connection of modules 300 from the busbars. BOSS module 600 only grants permissions to the modules 300 for the conditions when they are able to connect and disconnect. Each module 300a-300h uses internal MOSFET switches 903a-903h to rapidly open and close the circuit connections from the modules 300a-300h to the busbars 901, 902. Once a fully charged module 300d is connected, a module 300 at a lower state of charge can disconnect. For example, if module 300f is at 60% and the other modules 300 are above 80%, module 300f will disconnect and only reconnect once the other states of charge decrease to about 60%.

For at least these reasons, BOSS module 600, to the extent networked, is designed to monitor the states of charge in each module 300a-300h and will grant permission for a module 300a-300h that varies by more than some threshold to disconnect. This allows the forklift to continue operating without hindering performance. In preferred embodiments 36 V battery modules 300a-300h are used, but alternative embodiments can use various voltages depending on the needs of the particular lift truck. In some embodiments, modules 300a-300h can be 24 V or 48 V modules.

FIG. 10B is a schematic diagram of an alternative embodiment with a total of eight modules 300a-300h arranged in a series-parallel arrangement, where two groups of four modules 300 are arranged in parallel, and those parallel groups are placed in series to achieve a system voltage twice that of an individual module's voltage. Specifically, positive terminals 310 of modules 300a-300d are connected to positive busbar 901, and negative terminals of modules 300e-300h are connected to ground busbar 902. Module 300a is connected in serries with module 300e, module 300b is connected in series with module 300f, module 300c is connected in series with module 300g, and module 300d is connected in series with module 300h. One with skill in the art will understand that BOSS 600 and BMS 700a-700h can control each module's 300a-300h connection to busbars 901, 902 according to the disclosure above discussing FIG. 10A.

Other alternative embodiments of battery monitoring system architecture are contemplated within the scope of the present invention. In one embodiment, each battery module contains a slave PC board with only a digital isolator and a multi-cell battery stack monitor. Each module has an independent interface connection to a master controller board with a microcontroller, a CAN interface, and a galvanic isolation transformer. The master controller board centrally manages module temperature, voltages, and engagement/disengagement, in addition to providing the gateway to the forklift's main CAN bus.

In another alternative embodiment, each multi-cell battery stack monitor (MBSM) is on a PC board within each battery module. BMS 700 also contains a CAN transceiver and a galvanic isolation transformer. Each module communicates through the MBSM non-isolated serial interface. This structure requires a 3- or 4-conductor cable connected between battery modules. Only one microcontroller controls all the battery monitors through the bottom monitor integrated circuit. This microcontroller also serves as the gateway to the forklift's main CAN bus.

Another embodiment has no monitoring and control circuitry within any of the battery modules. One PC board has 3 MBSM integrated circuits (for 3 modules), each of which is connected to a battery module. The MBSM devices are able to communicate through non-isolated serial interfaces. One microcontroller controls all the battery monitors through the serial interface and is the gateway to the forklift's main CAN bus. Similar to the preceding disclosed embodiments, a CAN transceiver and a galvanic isolation transformer complete the BMS.

FIG. 11 is a flowchart illustrating a method 1100 for electrically connecting and disconnecting modules 300a-300h from busbars 901, 902. Method 1100 can start at block 1102 by determining operational information of battery cells 710. Specifically, each BMS 700a-700h can determine operational information of battery cells 710 of their respective cell array 322a-322h. Operational information can include any information related to the operation of cell array 322a-322h and their respective battery cells 710, including, for example, voltage level, current level, percentage charge level, and battery cell temperature.

Method 1100 can continue at block 1014 by determining if the acquired operational information conforms with predefined operational requirements. The predefined operational requirements can be threshold requirements that a module 300a-300h must comply with in order to be electrically connected with the other modules 300a-300h and busbar 901, 902, and thus provide power for operating forklift 130. For example, in some embodiments, BMS 700a-700h can determine if the acquired operational information of its respective cell array 322a-322h complies with voltage level requirements, percentage charge level requirement, and/or temperature requirements. The predefined operational requirements can be programmed into BMS 700a-700h and/or BOSS 600 by an operator of forklift 130 according to various factors, such as battery cell type and performance measures of forklift 130.

According to some embodiments, at block 1104, determining if the operational information of cell array 322a-322h complies with predefined requirements includes comparing operational information of one of cell array 322a-322h to the others of cell arrays 322a-322h to determine if the compared operational information is within an acceptable predefined range. For example, as previously discussed, BOSS 600 can communicate with BMSs 700a-700h and determine if one cell array 322a-322h has a charge level within a predefined range of the charge level of the other cell arrays 322a-322h. To illustrate this point, the predefined range of charge level can be set at 10%. One cell array 322a-322h may be at a 65% charge level while the other cell arrays 322a-322h are at an 80%. BOSS 600 would determine that the cell array 322a-322h at the 65% charge level is outside of the predefined 10% charge range of the other cells 322a-322h and thus does not comply with the predetermined requirements.

In response to determining, in block 1104, that the acquired operation information complies with the predefined operational requirements, the method can continue at block 1112 by electrically connecting module 300a-300h to busbars 901, 902. Specifically, BMS 700a-700h can close MOSFET 903a-903h to electrically connect cell array 322a-322h, and, in effect, the positive terminals 311 of modules 300a-300h, with positive busbar 901. If, before block 1112, MOSFET 903-903h is already closed, and thus module 300a-300h is already connected to busbars 901, 902, then the MOSFET 903-903h can remain closed in block 1112. In some embodiments, where BOSS 600 at block 1104 is comparing operational information of a cell array 322a-322h to other cell arrays 322a-322h as previously described, BOSS 600 can communicate to BMS 700a-700h to close its respective MOSFET 903-903h based on the comparison made.

In response to determining, in block 1104, that the acquired operation information does not comply with the predetermined operational information, the method can continue to block 1106 by disconnecting module 300a-300h. Specifically, BMS 700a-700h can open MOSFET 903a-903h to electrically disconnect cell array 322a-322h, and, in effect, the positive terminals 311 of modules 300a-300h, from positive busbar 901. If, before block 1106, MOSFET 903-903h is already opened, and thus module 300a-300h is already disconnected from busbars 901, 902, then the MOSFET 903-903h can remain open in block 1106. In some embodiments, where BOSS 600 at block 1104 is comparing operational information of a cell array 322a-322h to other cell arrays 322a-322h as previously described, BOSS 600 can communicate to BMS 700a-700h to close its respective MOSFET 903-903h based on the comparison made.

The method can continue from block 1106 to block 1108, by acquiring operational information while the module 300a-300h is disconnected from busbars 901, 902. The acquisition of operation information can be substantially the same as the acquisition described in block 1102.

The method can continue from block 1108 at block 1110, where it can be determined if the acquired operational information taken when module 300a-300h is disconnected from busbars 901, 902 complies with the predetermined operational requirements. The determination made at block 1110 can be substantially the same as the determination made at block 1104.

In response to determining, at block 1110, that the acquired operational requirements comply with the predefined operational requirements, the method can continue to block 1112 where the disconnected module 300a-300h can be connected to busbars 901, 902, as has been previously described. In response to determining, at block 1110, that the acquired operational does not comply with the predefined operational requirements, the method can continue back to 1108 to continue to acquire operational information until the operational information complies with the operational requirements.

Although blocks 1102-1112 of method 1100 are described as occurring in a certain order, one with skill in the art will understand that blocks 1102-1112 can be performed according to various orders without departing from the scope of this disclosure. Further, one with skill in the art will understand that steps can be added or removed from method 1100 without departing from the scope of this disclosure.

One with skill in the art will understand various scenarios in which method 1100 can be implemented with battery assembly 100. For example, method 1100 can be applied to compare charge levels of modules 300a-300h and to disconnect modules 300a-300h with low charge levels, as has been previously described.

Method 1100 can also be implemented to protect battery cells 710 from damage that occurs when the battery cells are discharged below a certain voltage level. In preferred embodiments, each battery cell 710 has a fully charged voltage of 3.65 V, and discharge of battery cell 710 to under 2.5 V can cause damage to battery cell 710. To incorporate multiple safety factors, BOSS 600 and/or BMS 700a-700f is set to recognize that battery cells 710 are at a 0% charge when battery cells 710 have a 2.7 V output, which is slightly above the undesirable output of 2.5 V. Further BOSS 600 and/or BMS 700a-700f is configured to open a module's 300a-300h MOSFET switch 903a-903h to disconnect the module 300a-300h from the busbars 901, 902 in response to detecting that the battery cells 710 of the module 300a-300h are at a 7% charge. Thus, the battery cells 710 are prevented from being further discharged to a point of damaging the cells 710.

### Method of Heating Battery Cells Prior to Charging

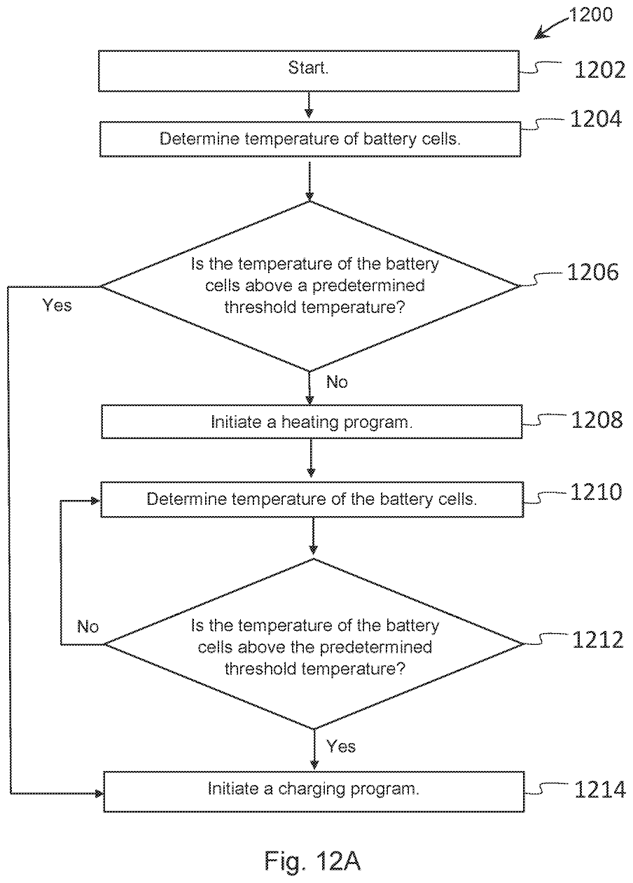

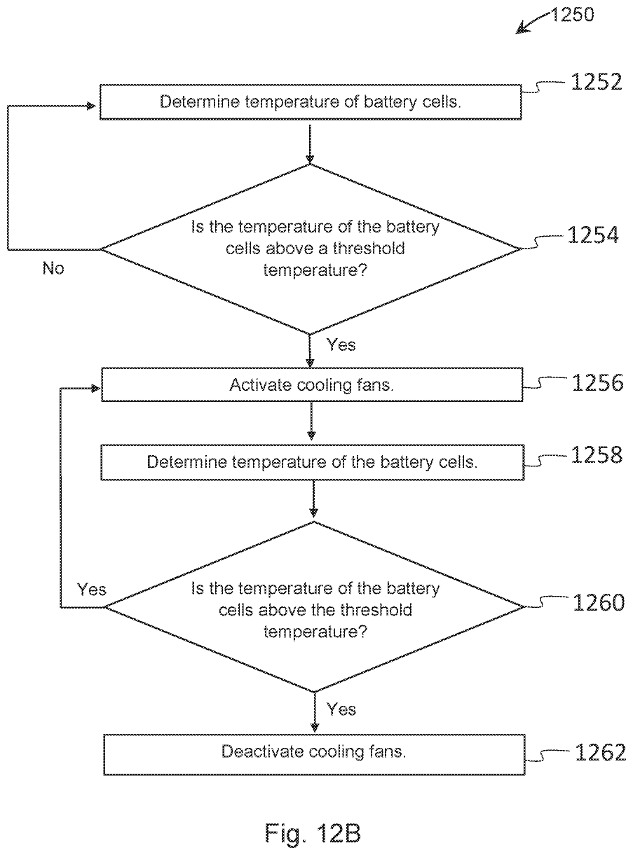

FIG. 12A is a flowchart illustrating a method 1200 for heating and interior of each battery module 300 to increase the temperature of the associated lithium-ion battery cells 710 prior to recharging battery assembly 10 with power source 200 when an estimated temperature of the battery cells 710 is below a temperature threshold. IN some embodiments, an as described herein, the method 1200 can be performed by each BMS 700 for its respective battery module 300. However, in other embodiment, method 1200 can be performed by BOSS 600 for all modules 300. The temperature threshold can be set between 0° C. and 5° C. The method can begin at block 1202. In some embodiments, the method can begin at block 300 by BMS 700 detecting an incoming charge from power source 200, indicating the start of a charging program by external power source 200.

The method can continue at block 1204 by determining a temperature of battery cells 210. BMS 700 uses temperature measurements from thermistors 812 proximal lithium-ion battery cells 710 that are continuously measured to determine a temperature of the battery cells 710. Alternatively, the temperature measurements may be measured intermittently. As previously discussed, thermally conductive material 726b connects each thermistor 812 to a corresponding battery cell 710, thus improving the temperature readings of the cells 710 and the model by which cell temperature is determined at block 1204. BMS 700 is configured to take the temperature readings from thermistors 812, taken in proximity to battery cells 710, and use the temperature readings in a calculation model to estimate the temperature of battery cells 710. The temperature of battery cells 710 determined by BMS 700 can be referred to as an estimated battery temperature since retrieving actual temperature readings from inside battery cells 710 would be impractical, and BMS 700 takes temperature readings using thermistors 312, which contact battery cells 710 via filler material 726b to estimate the temperature of battery cells 710. In estimating the temperature of battery cells 710, BMS 700 may incorporate a temperature calculation model that considers a number of different factors related to the temperature of battery cells 710.

The method can continue at block 1206 by BMS 700 determining if the estimated temperature of the battery cells 710, estimated in block 1204, is above or below a predetermined threshold temperature. The predetermined threshold can be a threshold temperature that is programmed by a user depending on temperature and charging properties of battery cells 710. Battery cells 710 can be damaged when they are charged at freezing or near freezing temperatures. Accordingly, in some embodiments, the threshold temperature can be between 0° C. and 5° C. to ensure that the battery cells are not charged at freezing or below-freezing temperatures.

In response to determining, in block 1206, that the battery temperature is above the threshold temperature, the method can continue at block 1214 by initiating a battery cell 710 charging program. During charging program, BMS 700 can direct the incoming charge from the external power source 200 to battery cells 710 to charge battery cells 710. As previously discussed, battery cells 710 can become damaged when charging occurs at below freezing or near-freezing temperatures (0° C.-5° C.). Accordingly, when the battery temperature is determined to be above the protective threshold value, battery cells 710 can be charged without fear of damaging cells 710.

In response to determining, in block 1206, that the battery temperature is below or equal to the predetermined threshold temperature, the method can continue at block 1208 by initiating a heating program. During the heating program, BMS 700 can direct power from a power source to resistive heaters 810 to raise the internal temperature of the battery module 300 and the associated battery cells 710. In some embodiments, BMS 700 directs the incoming power from external power source 200 to the heaters 810. In some embodiments, BMS 700 directs power from battery cells 710 to heaters 810.

The method can continue at block 1210 by determining the temperature of the battery cells during the heating program. The temperature of the battery cells can be determined using the substantially the same techniques described in block 1204.

The method can continue at block 1212, by determining if the temperature of battery cells 710 during the heating program is above or below predetermined threshold temperature. The techniques for making the determination in block 1212 can be substantially the same as the techniques made to make the same determination in block 1206. In response to determining, at block 1212, that the temperature of battery cells 710 is above the predetermined threshold temperature, the method can continue at block 1214, where BMS 700 can initiate the charging program, as previously described above. The BMS 700 stops the heating program prior to initiating the charging program in block 1214. In response to determining, at block 1212, that the temperature of battery cells 710 is below or equal to the predetermined threshold temperature, the method can continue back to block 1210, where BMS 700 can continue to determine the temperature of the battery cells 710 during the heating program until the temperature of battery cells 710 is determined to be above the predetermined threshold value.

Although blocks 1202-1214 of method 1200 are described as occurring in a certain order, one with skill in the art will understand that blocks 1202-1214 can be performed according to various orders without departing from the scope of this disclosure. Further, one with skill in the art will understand that steps can be added or removed from method 1200 without departing from the scope of this disclosure.

### Method of Cooling Battery Cells

FIG. 12B is a flowchart illustrating a method 1250 of cooling battery cells 710. Method 1250 can start at block 1252 by determining temperature of battery cells 710. The temperature of battery cells 710 can be determined by BMS 700 using temperature readings from thermistors 812 in substantially the same way previously described in blocks 1210 and 1204. At block 1252, the temperature of cells 710 can be determined while forklift 130 is being used in operation and battery cells 710 are being used to power operation of forklift 130.

Method 1250 can continue at block 1254 by determining if the temperature of the cells 710 is above a threshold temperature. BMS 700 can determine if the temperature of battery cells 710 is above a desired operating temperature, which can be a predetermined threshold temperature set by an operator of forklift 130 or battery assembly 10. For example, in some embodiments, it may be undesirable for battery cells 710 to operate at or above a temperature 35° C., so the predetermined threshold temperature can be set at 35° C. In some embodiments, each BMS 700 sends the estimated temperature of battery cells 710, determined in block 1252, to BOSS 600, and BOSS 600 determines whether the temperature of battery cells 710 for each module 300 is above the predetermined threshold.

In some embodiments, the threshold temperature is set by BOSS 600 relevant to the ambient temperature. BOSS 600 is configured to measure the ambient temperature using a temperature sensor of BOSS 600. BOSS 600 can be programmed such that the threshold temperature for battery cells 710 is any temperature that exceeds the measured ambient temperature by a certain range. For example, BOSS 600 can be programmed to set the threshold temperature to be a temperature 5° C. above the measured ambient temperature. To illustrate this point, if battery cell 710 temperature is estimated to be 30° C. in block 1252, and BOSS 600 measures the ambient temperature to be 25° C., then BOSS 600 would determine in block 1254 that the estimated battery cell 710 temperature is above the predetermined threshold since the battery cell 710 temperature is 5° C. greater than the ambient temperature. In some embodiments, BOSS 600 can determine that the battery cell 710 temperature exceeds the threshold if either of a predetermined threshold temperature (i.e., a predetermined threshold temperature of 35° C., as discussed above) or a threshold relevant to the ambient temperature (i.e., a temperature greater than 5° C. above the measured ambient temperature) is surpassed. In response to determining, in block 1254, that the temperature of battery cells 710 is less than the threshold temperature, method 1250 can continue to back to block 1252 to determine the temperature of battery cells 710.

In response to determining, in block 1254, that the estimated temperature of battery cells 710 is above or equal to the threshold temperature, method 1250 can continue to block 1256 by activating cooling fans 106. In some embodiments, activation of cooling fans 106 can be performed by BOSS 600. In some embodiments, BOSS 600 can receive communications from the BMS 700 of each of the modules 300 regarding whether their respective battery cells 710 are above or below the threshold value. In other embodiments, as discussed above, BOSS 600 can determine whether the determined temperatures are above the threshold value. BOSS 600 can activate fans 106 according to the determination made in block 1254. When less than all of modules 300 have battery cells 710 above the predetermined temperature, BOSS 600 can activate all fans 106, or can activate less than all of the fans 106. If all modules 300 have battery cells 710 above the predetermined temperature, BOSS 600 can activate all of fans 106. After activating fans 106, method 1250 can continue at block 1258 by determining the temperature of battery cells 710 while fans 106 are activated. The temperature of battery cells 710 can be determined in block 1258 in substantially the same way it is determined in block 1252.

Method 1250 can continue at block 1260 by determining if the temperature of the battery cells 710 is still above the threshold temperature. The determination in block 1260 can be made in substantially the same way the determination in block 1254 is made. In response to determining, in block 1260, that the temperature of battery cells 710 is no longer above or equal to the threshold temperature, method 1250 can continue at block 1262 by deactivating fans 106. Similar to BOSS 600 activating fans in step 1256 according to its communications with the different BMSs 700, BOSS 600 can deactivate fans according to its communications with BMSs 700. In response to determining, in block 1260, that the temperature of battery cells 710 is still above the threshold temperature, the method can continue to block 1256 by continuing to active fans 106 and determining the temperature of battery cells 710 in block 1258 until the temperature of battery cells 710 is determined to be below the threshold temperature. In some embodiments, BOSS 600 is configured to build in 3° C. of hysteresis to the threshold temperature to limit cycling of fans 106 as battery cell 710 temperature rises and falls.

Although blocks 1252-1262 of method 1250 are described as occurring in a certain order, one with skill in the art will understand that blocks 1252-1262 can be performed according to various orders without departing from the scope of this disclosure. Further, one with skill in the art will understand that steps can be added or removed from method 1250 without departing from the scope of this disclosure.

### State of Charge

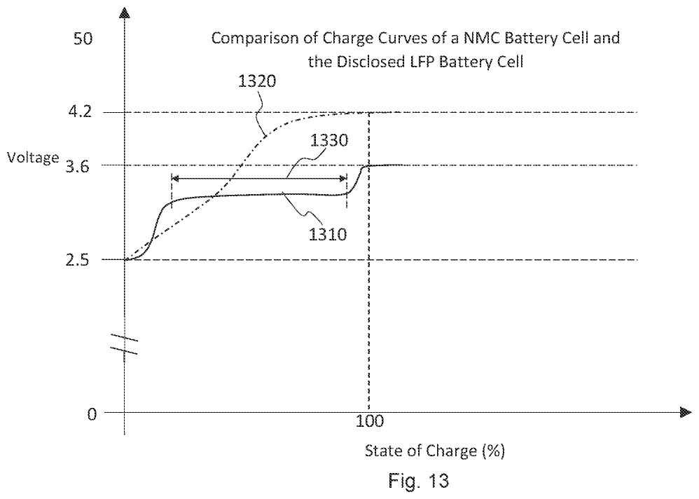

Referring to FIG. 13, there is shown a graphical representation comparing, over time, the charge curve 1320 of a single lithium nickel manganese cobalt oxide (NMC) battery cell and the charge curve 1310 of the disclosed LFP battery cell 710 utilized in the battery assembly 10. The charge curve of the NMC battery cell 1320 increases longer until it levels out at a higher voltage, shown here at 4.2 volts. In contrast, the LFP battery cell charge curve 1310 levels out sooner and remains at a constant voltage for longer. At the end of the charge cycle, LFP battery cell curve 1310 reaches 3.65 volts.

As is evident from the graph of FIG. 13, the charge curve 1320 of an NMC battery cell exhibits a substantially steady increase to its terminal voltage. In contrast, the charge curve 1310 of an individual LFP battery cell 710 initially increases relatively quickly to a flat portion of the curve. The charge curve 1310 remains relatively flat throughout most of the charge cycle.

The state of charge (“SOC”) of the lithium-ion battery cells 710 is continuously monitored by the BMS 700. When considering a state of charge curve, similar to the simplified graph seen in FIG. 13, lithium-ion battery cells 710 have a region where change in voltage is non-observable. This region, as seen in FIG. 13 as arrow 1330, shows that between approximately 5% charged and 80% charged, the ability to assess SOC for the lithium-ion battery cells 710 becomes difficult using standard methods. With the innovations of the current disclosure, the state of charge in this region is estimated using an equivalent-circuit cell model. The cell model output is comprised of two parts. The first part is an Open Circuit Voltage (“OCV”) which models the static voltage of the cell in an unloaded and equilibrium state. The second part is dynamic polarization of the cell voltage due to passage of current through the cell.

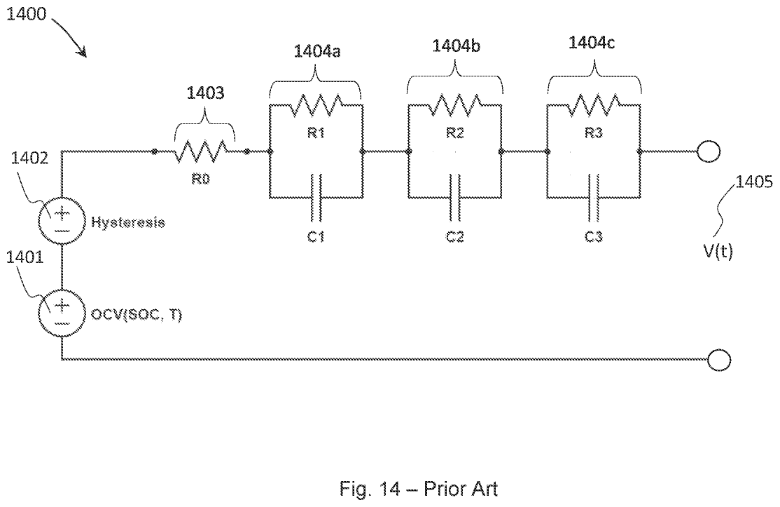

Referring to FIG. 14, the prior art shown is an “equivalent circuit” model 1400 used to simulate how a battery cell responds to certain load scenarios. The open circuit voltage source (“OCV”) 1401 models a battery cell with no load and in equilibrium. The OCV 1401 is a static function of state of charge (“SOC”) and Temperature (“T”). The hysteresis voltage 1402 models a departure of the cell's equilibrium rest voltage from OCV that depends on its current history. Theoretically, the hysteresis voltage is positive if the cell has been recently charged and is negative if the cell has been recently discharged. The hysteresis voltage 1402 has dynamics that are a function of cell current, and its magnitude may also be a function of SOC and cell current. Since the hysteresis voltage models how different the cell rest voltage is expected to be from OCV, neglecting the hysteresis voltage 1402 will result in SOC estimation errors. Resistor 1403 models the equivalent series resistance of the battery cells. The resistor-capacitor network pairs 1404a, 1404b, 1404c model the diffusion voltages of the battery cells 710 and approximate a Warburg Impedance. Those of skill in the art should know that Warburg Impedance models the diffusion of lithium ions in electrodes. A voltage differential 1405 can be observed using the equivalent circuit model 1400 as described. Using the equivalent circuit model 1400, along with the associated math, data sets that describe a battery cell's 710 input/output relationship can be generated. BMS 700 can then be calibrated to report a SOC sensibly during scenarios of varying load, temperature, and time conditions.

The processes for OCV characterization and dynamic parameter estimation make use of two independent data sets. During the calibration process, lithium-ion battery cells are tested in a cell cycler to acquire data. A cell cycler measures battery characteristics such as charge, maximum voltage, and minimum voltage. The OCV data includes measurements of current, voltage and charge at a number of temperature set points at, above, and below ambient temperature. The dynamic parameter estimation data includes measurements of current, voltage and charge, obtained similarly as the OCV data, with the addition of dynamic charge and discharge data. An Extended Kalman Filter (EKF) is programmed and calibrated into BMS 700 to estimate internal cell states based on the current input and voltage output of the battery cells. It should be known by those of skill in the art that the EKF is a numerical method used to indirectly estimate values for variables that cannot be directly measured. Although the EKF is not the sole contributor for determining the state of charge, the importance of its contribution within the current disclosure should be noted.

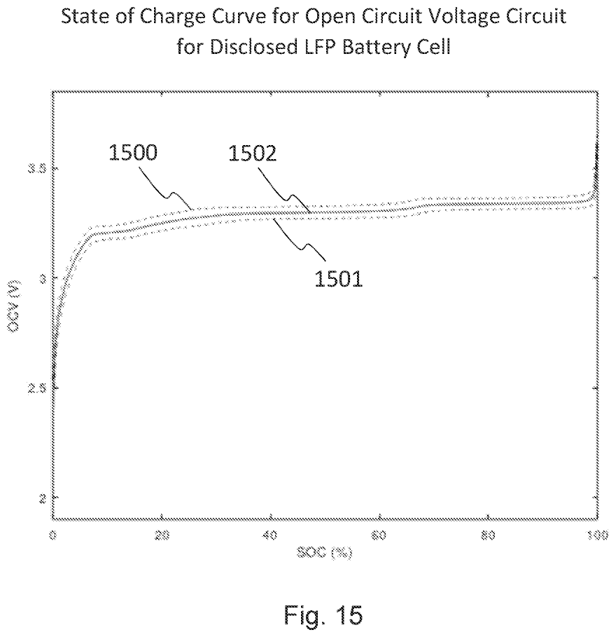

Referring to FIG. 15, a state of charge curve for the OCV model is shown. An OCV characterization uses low C-rate charge or discharge curves, shown as 1500 and 1501, to estimate a true OCV curve 1502 that lies between the measured curves 1500, 1501. The measured curves 1500, 1501 are generated from the data acquired using the cell cycler and methods as previously described. Those of skill in the art will know that the term “C-rate” refers to the level of a battery cell's discharge relative to the battery cell's capacity.

### Active Balancing

Referring to FIG. 16, there is shown a block diagram illustrating the strategy for implementing active balancing for battery banks 711a-711d. As previously mentioned, the plurality of battery cells 710 of module 300 can be electrically connected in separate battery banks 711a-711d. Active balancing refers to a circuit that distributes energy amongst battery banks 711a-711d. An active balance circuit 1600 allows for a net transfer of energy, shown as the arrow 1600 in FIG. 16, from a single bank 711a-711d to the remaining banks 711a-711d in the system. If the state of charge and/or voltage 1602 of bank 711a-711d is higher than the configurable limit, the respective circuit 1600 is activated. The circuit 1600 will discharge the bank 711a-711d at a calibrated set point, thus enabling the stored energy in bank 711a-711d to be transferred to the rest of the banks 711a-711d in the system. Each circuit is preferably capable of discharging a certain bank at a max rate of 2 amps. The discharge rate can be adjusted with a range from 0 amps to 2 amps. Alternative embodiments may have the capacity to support max discharge rates greater than 2 amps. Once the state of charge and/or voltage 1602 of bank 711a-711d is below the calibrated limit, the circuit 1800 will deactivate and cease energy transfer between banks 711a-711d.

The number of active balance circuits 1601a-1601d is equal to the number of banks 711a-711d connected in series, such that each bank 711a-711d has a circuit 1600 that operates independently from the other banks 711a-711d. For example, a module 300 equipped with four battery banks 711a-711d in series will have four active balance circuits 1601a-1601d. Each circuit 1601a-1601d operates independently to allow management for each respective bank 711a-711d; looking to FIG. 16, it is evident for illustrative purposes that active balance circuit 1601a is linked to battery bank 711a, the same relations are applicable for circuits 1601b-1601d and respective battery banks 711b-711d. Each circuit 1601b-1601d has numerous fail-safe mechanisms that force the circuit to a passive state if control is lost. It should be noted that the peak efficiency of each circuit is greater than 70%.

### Other Alternatives

Although the present invention has been described in terms of the foregoing disclosed embodiments, this description has been provided by way of explanation only, and is not intended to be construed as a limitation of the invention. For instance, despite reference to Class I and II forklifts as such, it should be understood that some aspects of the invention may have broader application with other types of battery-powered industrial trucks. Indeed, even though the foregoing descriptions refer to numerous components and other embodiments that are presently contemplated, those of ordinary skill in the art will recognize many possible alternatives that have not been expressly referenced or even suggested here. While the foregoing written descriptions should enable one of ordinary skill in the pertinent arts to make and use what are presently considered the best modes of the invention, those of ordinary skill will also understand and appreciate the existence of numerous variations, combinations, and equivalents of the various aspects of the specific embodiments, methods, and examples referenced herein.

Hence the drawings and detailed descriptions herein should be considered illustrative, not exhaustive. They do not limit the invention to the particular forms and examples disclosed. To the contrary, the invention includes many further modifications, changes, rearrangements, substitutions, alternatives, design choices, and embodiments apparent to those of ordinary skill in the art, without departing from the spirit and scope of this invention.

Accordingly, in all respects, it should be understood that the drawings and detailed descriptions herein are to be regarded in an illustrative rather than a restrictive manner, and are not intended to limit the invention to the particular forms and examples disclosed. In any case, all substantially equivalent systems, articles, and methods should be considered within the scope of the invention and, absent express indication otherwise, all structural or functional equivalents are anticipated to remain within the spirit and scope of the presently disclosed systems and methods.

1. A rechargeable lithium-ion battery assembly configured to provide electric power to a vehicle, the rechargeable battery assembly comprising:
a housing sized and shaped to operatively fit within a battery compartment of the vehicle; and
a plurality of battery cell subassemblies disposed in an interior of the housing, each of the plurality of battery cell subassemblies comprising:
a subassembly casing,
a positive terminal and a negative terminal disposed to be accessible from outside the subassembly casing,
a plurality of lithium-ion battery cells disposed within the casing and interconnected with the positive and negative terminals to provide a combined electrical potential between the positive and negative terminals, and
a printed circuit board (PCB) disposed in an orientation relative to the plurality of battery cells within the casing such that a first end of each of the plurality of battery cells is adjacent to the PCB, said PCB further comprising:
a collector plate electrically coupled with each of the plurality of battery cells, and
a subassembly processor configured to obtain real-time operational information about the plurality of battery cells,
wherein, for each of the plurality of battery cells:
a first thermally conductive gap tiller is disposed to contact the first end of the battery cell and to contact the collector plate, the first thermally conductive gap filler configured to transfer heat between the collector plate and the battery cell, and
a second thermally conductive gap filler is disposed to contact a second end of the battery cell and to contact the subassembly casing, the second thermally conductive gap filler configured to transfer heat between the battery cell and the subassembly casing.

2. The rechargeable battery assembly of claim 1, wherein the rechargeable battery assembly is configured to provide electric power to an industrial forklift.

3. The rechargeable battery assembly of claim 1, wherein, for each of the plurality of battery cell subassemblies:
the PCB further comprises a plurality of thermistors disposed on the collector plate and electrically connected with the subassembly processor; and
the subassembly processor is configured to take temperature measurements using the plurality of thermistors.

4. The rechargeable battery assembly of claim 3, wherein, for each of the plurality of battery cell subassemblies:
each of the plurality of thermistors is disposed on the collector plate to contact one of the first thermally conductive gap fillers; and
for each of the plurality of thermistors, the thermistor is configured to measure a temperature of the first thermally conductive gap filler, which is in contact with one of the plurality of battery cells.

5. The rechargeable battery assembly of claim 3, wherein:
each subassembly processor is configured to determine an estimated battery temperature for the plurality of battery cells in its battery cell subassembly based on the temperature measurements from the plurality of thermistors;
the rechargeable battery assembly further comprises:
a plurality of cooling fans configured to cool the plurality of battery cell subassemblies by moving air past the battery cell subassemblies, and
a supervisory processor configured to:
communicate with each subassembly processor to obtain the estimated battery temperature of each battery cell subassembly, and
activate the cooling fans in response to determining that one of the estimated battery temperatures for a battery cell subassembly is above a threshold temperature.

6. The rechargeable battery assembly of claim 5, wherein the threshold temperature is a predetermined threshold temperature programmed to the supervisory processor.

7. The rechargeable battery assembly of claim 5, wherein the threshold temperature is determined by the supervisory processor relative to an ambient temperature.

8. The rechargeable battery assembly of claim 1, wherein:
the subassembly casing comprises a base and a cover,
the base disposed to be in contact with the second thermally conductive gap fillers; and
the base is comprised of aluminum.

9. The rechargeable battery assembly of claim 1, wherein, for each of the plurality of battery cell subassemblies, each of the plurality of battery cells is a lithium iron phosphate battery cell.

10. The rechargeable battery assembly of claim 1, wherein each of the first and the second thermally conductive gap fillers comprises a silicone-based material.

11. An electrically-powered forklift truck configured to be powered by a battery power source, comprising:
a battery assembly compartment; and
a battery assembly configured to provide electrical power to the forklift truck and disposed within the battery assembly compartment, the battery assembly including:
an assembly housing sized to operatively fit within the battery assembly compartment; and
a plurality of battery cell subassemblies disposed in an interior of the assembly housing, each of the plurality of battery cell subassemblies including:
a subassembly casing,
a positive terminal and a negative terminal disposed to be accessible from an outside of the subassembly casing,
a plurality battery cells disposed within the subassembly casing and interconnected with the positive and negative terminals to provide a combined electrical potential between the positive and negative terminals, and
a printed circuit board assembly (PCBA) disposed within the subassembly casing adjacent to a first end of each of the plurality of battery cells, the PCBA including:
a collector plate electrically coupled with each of the plurality of battery cells, and
a battery management system (BMS) configured to obtain real-time operational information of the plurality of battery cells,
wherein, for each of the plurality of battery cells:
a first thermally conductive gap filler is disposed to contact the first end of the battery cell and to contact the collector plate, the first thermally conductive gap filler configured to transfer heat between the collector plate and the battery cell, and
a second thermally conductive gap filler is disposed to contact a second end of the battery cell and to contact the subassembly casing, the second thermally conductive gap filler configured to transfer heat between the battery cell and the subassembly casing.

12. The forklift truck of claim 11, wherein, for each of the plurality of battery cell subassemblies:
the PCBA further comprises a plurality of thermistors disposed on the collector plate and electrically connected with the BMS; and
the BMS is configured to take temperature measurements using the plurality of thermistors.

13. The forklift truck of claim 12, wherein, for each of the plurality of battery cell subassemblies:
each of the plurality of thermistors is disposed on the collector plate to contact one of the first thermally conductive gap fillers; and
for each of the plurality of thermistors, the thermistor is configured to measure a temperature of the first thermally conductive gap filler, which is in contact with one of the plurality of battery cells.

14. The forklift truck of claim 12, wherein:
each BMS is configured to determine an estimated battery temperature for the plurality of battery cells in its battery cell subassembly based on the temperature measurements from the plurality of thermistors;
the battery assembly further comprises:
a plurality of cooling fans configured to cool the plurality of battery cell subassemblies by moving air past the battery cell subassemblies, and
a Battery Operating System Supervisor (BOSS) module configured to:
communicate with each BMS to obtain the estimated battery temperature of each battery cell subassembly, and
activate the cooling fans in response to determining that one of the estimated battery temperatures for a battery cell subassembly is above a threshold temperature.

15. The forklift truck of claim 14, wherein the threshold temperature is at least one of multiple predetermined threshold temperatures and a temperature determined by the supervisory processor relative to an ambient temperature.

16. A rechargeable battery assembly comprising:
an assembly casing;
a positive terminal and a negative terminal disposed to be accessible from an outside of the assembly casing;
a plurality of battery cells disposed within the assembly casing and interconnected with the positive and negative terminals to provide a combined electrical potential between the positive and negative terminals; and
a printed circuit board (PCB) disposed within the assembly casing adjacent to a first end of each of the plurality of battery cells and comprising a collector plate electrically coupled with each of the plurality of battery cells,
wherein, for each of the plurality of battery cells:
a first thermally conductive gap filler is disposed to contact the first end of the battery cell and to contact the collector plate, the first thermally conductive gap filler configured to transfer heat between the collector plate and the battery cell, and
a second thermally conductive gap filler is disposed to contact a second end of the battery cell and to contact the assembly casing, the second thermally conductive gap filler configured to transfer heat between the battery cell and the assembly casing.

17. The rechargeable battery assembly of claim 16, wherein the PCB further comprises:
a plurality of thermistors disposed on the collector plate; and
an assembly processor configured to take temperature measurements using the plurality of thermistors.

18. The rechargeable battery assembly of claim 17, wherein:
each of the plurality of thermistors is disposed on the collector plate to contact one of the first thermally conductive gap fillers; and
for each of the plurality of thermistors, the thermistor is configured to measure a temperature of the first thermally conductive gap filler, which is in contact with one of the plurality of battery cells.

19. The rechargeable battery assembly of claim 17, wherein the battery assembly is part of a battery system, the battery system including:
a cooling fan positioned to cool the battery assembly; and
a supervisory controller configured to:
communicate with the assembly processor to obtain an estimated battery temperature of the battery cells estimated by the assembly processor using measurements from the plurality of thermistors, and
activate the cooling fan in response to determining that the estimated battery temperature is above a threshold temperature.

20. The battery assembly of claim 16, wherein:
each of the plurality of battery cells is a lithium-ion battery;
a base of the assembly casing, which is in contact with the second thermally conductive gap fillers, is comprised of aluminum; and
each of the first and the second thermally conductive gap fillers comprises a silicone-based material.
